(19) United States
(12) Patent Application Publication
(10) Pub. No.: US 2015/0043885 A1
(43) Pub. Date: Feb. 12, 2015

(54) VIDEO DISPLAY APPARATUS AND VIDEO DISPLAY METHOD

(71) Applicant: Kabushiki Kaisha Toshiba, Minato-ku (JP)

(72) Inventor: Tomoo YAMAKAGE, Yokohama (JP)

(73) Assignee: Kabushiki Kaisha Toshiba, Minato-ku (JP)

(21) Appl. No.: 14/485,237

(22) Filed: Sep. 12, 2014

Related U.S. Application Data
(63) Continuation of application No. PCT/JP2013/078881, filed on Oct. 24, 2013.

(30) Foreign Application Priority Data
Jan. 25, 2013 (JP) PCT/JP2013/051565

(51) Int. Cl. H04N 21/43; H04N 21/643; G11B 27/10; H04N 21/438; G11B 20/00; G11B 27/00

(52) U.S. Cl. CPC H04N 21/4307; G11B 20/00007; G11B 27/005; G11B 27/10; H04N 21/4382; H04N 21/64315; H04N 21/64322; G11B 2020/00072
USPC 386/207

(57) ABSTRACT

According to an embodiment, an information processor includes a first decoder, a controller and a display unit. The first decoder decodes the first video encoded data at a first speed to generate a first video. When the first video encoded data is received earlier than the second video encoded data, the controller controls the first speed so as to generate a period in which the first speed becomes lower than a ×1 speed until second time information of the second decoder catches up with first time information of the first decoder. When the first video encoded data is received earlier than the second video encoded data, the first video is displayed at the first speed until the second time information catches up with the first time information.

### CROSS-REFERENCE TO RELATED APPLICATIONS

This application is a Continuation application of PCT Application No. PCT/JP2013/078881, filed Oct. 24, 2013 and based upon and claiming the benefit of priority from PCT Application No. PCT/JP2013/051565, filed Jan. 25, 2013, the entire contents of all of which are incorporated herein by reference.

### FIELD

Embodiments described herein relate generally to decoding and display of a video.

### BACKGROUND

In one kind of video transmission scheme (for example, digital broadcasting), conventionally, video encoded data is transmitted via a dedicated channel (for example, radio wave (especially broadcast wave) channel or dedicated line). The video encoded data is received by a video display apparatus. Assuming that a constant delay occurs in, for example, a dedicated line, the video display apparatus decodes and displays the video encoded data based on the STD (Standard Target Decoder) model described in the MPEG-2 Systems standard (ISO/IEC 13818-1). In addition, for example, the video display apparatus sometimes sequentially decodes received video encoded data, stores the decoded video in a buffer for decoded video, and controls the display operation of the stored video based on a display timing. Note that a modification of this video display apparatus is known to pause decoding at the occurrence of overflow in the buffer for decoded video.

Along with the recent development of the Internet (especially public network) to broadband, a video transmission scheme of transmitting video encoded data via the Internet has become operational. However, the Internet has the properties of readily increasing the transmission delay and readily varying (jittering). When decoding and displaying video encoded data from a channel that readily changes the transmission delay, like the Internet, overflow or underflow readily occurs in the encoded data buffer that stores the video encoded data. Regarding this problem, controlling the reproduction speed of the decoder based on the occupied amount of the encoded data buffer is known. For example, when the occupied amount of the encoded data buffer is increasing, the reproduction speed is controlled to be higher. When the occupied amount is decreasing, the reproduction speed is controlled to be slower.

Research and development has been conducted on synchronously decoding and displaying video encoded data transmitted via not a single channel but a plurality of channels (for example, broadcast wave and Internet). However, since transmission delays in the plurality of channels are not equal in quantity in general, it is not easy to synchronously decode and display the video encoded data transmitted via them. For example, when decoding and display of video encoded data are started in synchronism with video encoded data from a channel having the longest transmission delay, these video encoded data can synchronously be decoded and displayed. According to this technique, however, since the video display start timing is decided depending on the channel having the longest transmission delay, the display wait time especially after the reception target channel has been switched becomes long. During the reception wait time, the viewer cannot view the video from the reception target channel at all.

### BRIEF DESCRIPTION OF THE DRAWINGS

FIG. 1 is a block diagram showing a video display apparatus according to the first embodiment.

FIG. 2 is a timing chart showing the operation of the video display apparatus according to the first embodiment.

FIG. 3 is a block diagram showing a decoder according to the first embodiment.

FIG. 4 is a block diagram showing a decoder according to the fourth embodiment.

FIG. 5 is a timing chart showing the operation of the video display apparatus according to the first embodiment.

FIG. 6 is a timing chart showing the operation of a video display apparatus according to the second embodiment.

FIG. 7 is a timing chart showing the operation of a video display apparatus according to the third embodiment.

FIG. 8 is a block diagram showing a video display apparatus according to the fifth embodiment.

FIG. 9 is a timing chart showing the operation of the video display apparatus according to the fifth embodiment.

FIG. 10 is a timing chart showing the operation of the video display apparatus according to the fifth embodiment.

FIG. 11 is a view showing display control information.

FIG. 12 is a timing chart showing the operation of the video display apparatus according to the fifth embodiment.

FIG. 13A is a view showing an image included in a video generated by decoding video encoded data transmitted via a first channel.

FIG. 13B is a view showing an image included in a video generated by decoding video encoded data transmitted via a second channel.

FIG. 14 is a view showing an image based on the images included in the videos shown in FIGS. 13A and 13B.

FIG. 15A is a view showing an image based on the images included in the videos shown in FIGS. 13A and 13B.

FIG. 15B is a view showing a subimage based on the images included in the videos shown in FIGS. 13A and 13B.

FIG. 16A is a view showing an image included in a video generated by decoding video encoded data transmitted via a first channel.

FIG. 16B is a view showing an image included in a video generated by decoding video encoded data transmitted via a second channel.

FIG. 17 is a view showing an image based on the images included in the videos shown in FIGS. 16A and 16B.

FIG. 18 is a view showing a video generated by decoding video encoded data transmitted via two different channels.

### DETAILED DESCRIPTION

Embodiments will now be described with reference to the accompanying drawings.

According to an embodiment, an information processor includes a first decoder, a second decoder and a controller. The first decoder receives first video encoded data via a first channel and decodes the first video encoded data at a first speed to generate a first video. The second decoder receives second video encoded data via a second channel different from the first channel and decodes the second video encoded data at a second speed to generate a second video. When the first video encoded data is received earlier than the second video encoded data, the controller controls the first speed so as to generate a period in which the first speed becomes lower than a ×1 speed until second time information of the second decoder catches up with first time information of the first decoder. When the first video encoded data is received earlier than the second video encoded data, the first video is displayed at the first speed until the second time information catches up with the first time information.

Note that the same or similar reference numerals as those of already explained elements denote the same or similar elements hereinafter, and a repetitive description thereof will basically be omitted.

In the following description, the term video means an image (moving picture more exactly) but may be replaced with one or both of image and audio. For example, the video may be a slideshow in which image and audio are presented in synchronization. In addition, the video may include a text (for example, a closed caption) which is synchronized with image and/or audio. The video may include graphics which is overlaid with displayed image. The graphics may be generated by an application such as data broadcasting. Similarly, the term video display means image display but may be replaced with one or both of image display and audio output.

### First Embodiment

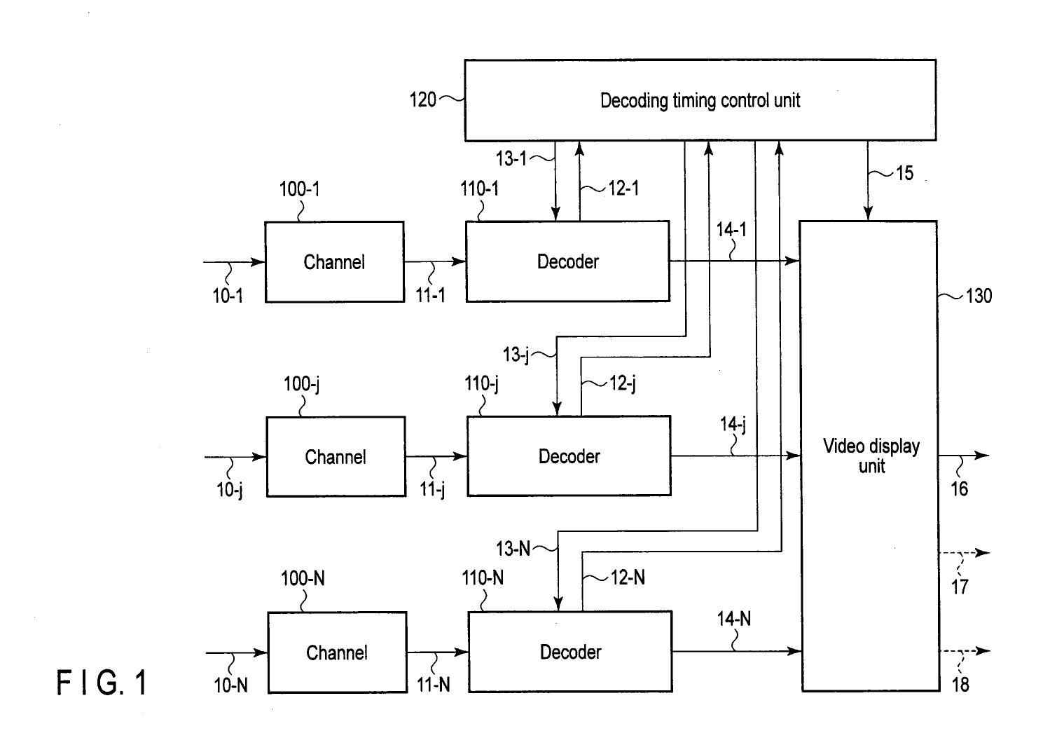

As shown in FIG. 1, a video display apparatus according to the first embodiment includes N (N is an integer: N≧2) decoders 110-1, . . . , 110-j (j is an integer: 2≦j<N), . . . , 110-N, a decoding timing control unit 120, and a video display unit 130. The video display apparatus shown in FIG. 1 can synchronously decode and display video encoded data transmitted via N different channels 100-1, . . . , 100-j, . . . , 100-N. Note that although N=3 in the example of FIG. 1, N may be 2 or 4 or more.

The channel 100-1 transmits video encoded data 10-1 output from a transmission apparatus (not shown). The decoder 110-1 receives video encoded data 11-1 via the channel 100-1. The video encoded data 11-1 is discriminated from the video encoded data 10-1 by a transmission delay in the channel 100-1.

The video encoded data 10-1 (and video encoded data 11-1) can be, for example, Transport Stream of the MPEG-2 Systems standard. The video encoded data 10-1 (and video encoded data 11-1) may be a multimedia container storing time information of arrival of the stream and information of the decoding timing and reproduction timing of the stream. Note that the video encoded data 10-1 (and video encoded data 11-1) may be a multimedia container that prepares information used to compensate for an offset between time information so as to enable synchronous display even when time information described in the main stream and that described in the substream differ.

The decoder 110-1 controls a clock (for example, STC (System Time Clock) counter) in it based on time information (for example, PCR (Program Clock Reference) in the MPEG-2 Systems standard) included in the video encoded data 11-1. The decoder 110-1 outputs time information 12-1 (for example, STC counter value) measured by the clock to the decoding timing control unit 120.

The decoder 110-1 receives decoding timing control information 13-1 from the decoding timing control unit 120. The decoder 110-1 decodes the video encoded data 11-1 based on the decoding timing control information 13-1, thereby generating a video 14-1. The decoder 110-1 outputs the video 14-1 to the video display unit 130.

Note that in the above description, the channel 100-1, the decoder 110-1, the video encoded data 10-1, the video encoded data 11-1, the time information 12-1, the decoding timing control information 13-1, and the video 14-1 may be replaced with the channel 100-j, the decoder 110-j, video encoded data 10-j, video encoded data 11-j, time information 12-j, decoding timing control information 13-j, and a video 14-j, or the channel 100-N, the decoder 110-N, video encoded data 10-N, video encoded data 11-N, time information 12-N, decoding timing control information 13-N, and a video 14-N. The time information 12-1, . . . , 12-N may indicate relative time based on a common time domain (wall clock) among the decoders 110-1, . . . , 110-N.

At least some of the channels 100-1, . . . , 100-j, . . . , 100-N may be, for example, channels for terrestrial digital broadcasting, BS (Broadcasting Satellite) digital broadcasting, or CS (Communications Satellite) digital broadcasting, or channels for cable TV. Alternatively, at least some of the channels 100-1, . . . , 100-j, . . . , 100-N may be composed by an IP (Internet Protocol) network corresponding to a dedicated network or public network.

More specifically, a first channel and a second channel, which form an arbitrary pair of the channels 100-1, . . . , 100-j, . . . , 100-N, can be those as described below.

The first channel may be a channel for digital broadcasting (that is, a channel for terrestrial digital broadcasting, BS digital broadcasting, or CS digital broadcasting, or cable TV), and the second channel may be an IP network.

The first channel and the second channel may both be channels for digital broadcasting but in different physical layers. For example, the first channel may be a channel for terrestrial digital broadcasting, and the second channel may be a channel for BS digital broadcasting.

The first channel and the second channel may both be channels for digital broadcasting of the same physical layer but in different logical layers. For example, the first channel may be a channel for so-called full-segment broadcasting as a part of terrestrial digital broadcasting, and the second channel may be a channel for so-called one-segment broadcasting as a part of terrestrial digital broadcasting.

The decoding timing control unit 120 receives the time information 12-1 from the decoder 110-1. Based on the operation states of the decoders (including the decoders 110-1, 110-j, and 110-N), the decoding timing control unit 120 outputs, to the decoder 110-1, the decoding timing control information 13-1 for operating the decoder 110-1 at the ×1 speed or a speed lower than the ×1 speed.

More specifically, if all the remaining decoders are operating at the start of the operation of the decoder 110-1, the decoding timing control unit 120 outputs, to the decoder 110-1, the decoding timing control information 13-1 for operating the decoder 110-1 at the ×1 speed. On the other hand, if at least one of the remaining decoders is not operating at the start of the operation of the decoder 110-1, the decoding timing control unit 120 outputs, to the decoder 110-1, the decoding timing control information 13-1 for operating the decoder 110-1 at a speed lower than the ×1 speed. If time information from another decoder that is operating at the ×1 speed catches up with the time information 12-1 during the operation of the decoder 110-1 at a speed lower than the ×1 speed, the decoding timing control unit 120 outputs, to the decoder 110-1, the decoding timing control information 13-1 for operating the decoder 110-1 at the ×1 speed.

Note that in the above description, the decoder 110-1, the video encoded data 11-1, the time information 12-1, and the decoding timing control information 13-1 may be replaced with the decoder 110-j, the video encoded data 11-j, the time information 12-j, and the decoding timing control information 13-j, or the decoder 110-N, the video encoded data 11-N, the time information 12-N, and the decoding timing control information 13-N.

The decoding timing control unit 120 can determine the operation states of the decoders 110-1, . . . , 110-j, . . . , 110-N via the pieces of time information 12-1, . . . , 12-j, . . . , 12-N. The decoding timing control unit 120 outputs decoder operation information 15 representing the operation states of the decoders 110-1, . . . , 110-j, . . . , 110-N to the video display unit 130.

The video display unit 130 receives the videos 14-1, . . . , 14-j, . . . , 14-N from the decoders 110-1, . . . , 110-j, . . . , 110-N and the decoder operation information 15 from the decoding timing control unit 120. The video display unit 130 can detect the operation states of the decoders 110-1, . . . , 110-j, . . . , 110-N via the decoder operation information 15.

If the decoders 110-1, . . . , 110-j, . . . , 110-N are operating at the ×1 speed, the video display unit 130 displays the videos 14-1, . . . , 14-j, . . . , 14-N at the ×1 speed.

For example, the video display unit 130 displays an image 16 generated by combining images included in some or all of the videos 14-1, . . . , 14-j, . . . , 14-N. Combining images can be done by either overlay or blending. More specifically, the image 16 that displays a plurality of images of different sizes in a picture-in-picture mode may be generated. Alternatively, the one image 16 may be generated by equalizing the numbers of pixels of a plurality of images including different numbers of pixels and adding the images on a pixel basis.

The video display unit 130 may output a subimage 17 based on images included in some of the videos 14-1, . . . , 14-j, . . . , 14-N. The subimage 17 can be either a combination of the images included in some of the videos 14-1, . . . , 14-j, . . . , 14-N or an image included in one of the videos 14-1, . . . , 14-j, . . . , 14-N. The subimage 17 is an image for multidisplay and is displayed on a subdisplay (not shown), unlike the image 16. The video display unit 130 may also output audio 18 based on pieces of audio included in some or all of the videos 14-1, . . . , 14-j, . . . , 14-N. The pieces of audio included in some of the videos 14-1, . . . , 14-j, . . . , 14-N may be used to extend the number of surround channels.

If at least one of the decoders 110-1, . . . , 110-j, . . . , 110-N is not operating at the ×1 speed, the video display unit 130 displays one of the videos 14-1, . . . , 14-j, . . . , 14-N at the same speed as the operation speed of a corresponding decoder (typically a decoder that has started the operation earliest).

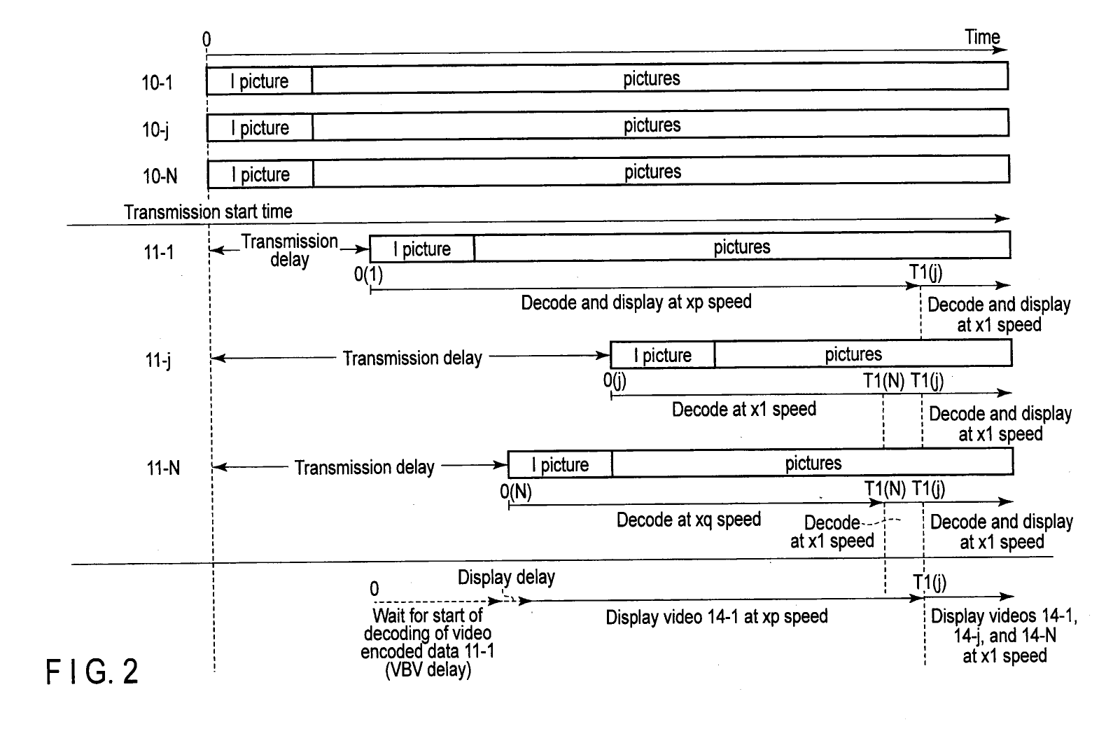

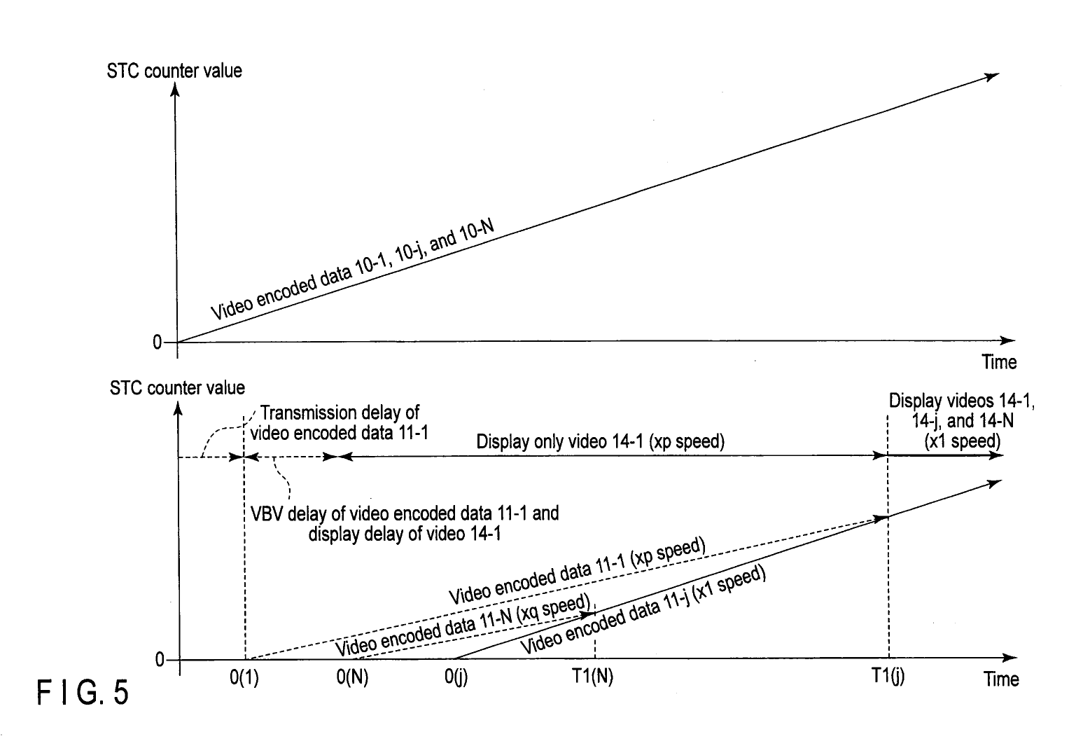

FIGS. 2 and 5 show the operation of the video display apparatus shown in FIG. 1. In the examples of FIGS. 2 and 5, the video encoded data 10-1, 10-j, and 10-N have the same transmission start timing, and also have the same display timing (and output timing). In the example of FIG. 5, the display timing (and output timing) are expressed using STC counter values. Note that the video encoded data 10-1, 10-j, and 10-N may have different display timings (and output timings). In this case, for example, additional information representing the offset of the display timing (and output timing) between the video encoded data may be transmitted.

In the examples of FIGS. 2 and 5, assume that the video 14-1 corresponds to a video serving as a base, the video 14-N corresponds to an additional video displayed in synchronism with the video 14-1, and the video 14-j corresponds to an additional video displayed in synchronism with the videos 14-1 and 14-N. Also assume that the transmission delay in the channel 100-1 is the shortest, and the transmission delay in the channel 100-j is the longest.

Since the channel 100-1 has the shortest transmission delay, the video encoded data 11-1 is received by the decoder 110-1 at a time (0(1)) earlier than the video encoded data 11-j and 11-N. The decoder 110-1 controls the clock in it based on time information included in the video encoded data 11-1. The decoder 110-1 outputs the time information 12-1 measured by the clock to the decoding timing control unit 120.

The decoding timing control unit 120 receives the time information 12-1 from the decoder 110-1. At this time, since the decoders 110-j and 110-N are not operating, the decoding timing control unit 120 outputs, to the decoder 110-1, the decoding timing control information 13-1 for operating the decoder 110-1 at the ×p speed. Here, p is a value smaller than 1.

The decoder 110-1 receives the decoding timing control information 13-1. Based on the decoding timing control information 13-1, the decoder 110-1 generates the video 14-1 by decoding the video encoded data 11-1 at the ×p speed and outputs it to the video display unit 130. The video display unit 130 receives the video 14-1 and displays it. The display speed of the video 14-1 is the ×p speed because it depends on the operation speed of the decoder 110-1.

Since the channel 100-N has the second shortest transmission delay, the video encoded data 11-N is received by the decoder 110-N at a time (0(N)) earlier than the video encoded data 11-j. The decoder 110-N controls the clock in it based on time information included in the video encoded data 11-N. The decoder 110-N outputs the time information 12-N measured by the clock to the decoding timing control unit 120.

The decoding timing control unit 120 receives the time information 12-N from the decoder 110-N. At this time, since the decoder 110-j is not operating, the decoding timing control unit 120 outputs, to the decoder 110-N, the decoding timing control information 13-N for operating the decoder 110-N at the ×q speed. Here, q is a value smaller than 1. Note that q may be larger than p but is preferably equal to or smaller than p. In the case where q≦p, before the time information 12-j of the decoder 110-j catches up with the time information 12-1 of the decoder 110-1 (that is, the video 14-1 under display), the time information 12-j catches up with the time information 12-N of the decoder 110-N.

The decoder 110-N receives the decoding timing control information 13-N. Based on the decoding timing control information 13-N, the decoder 110-N generates the video 14-N by decoding the video encoded data 11-N at the ×q speed and outputs it to the video display unit 130. The video display unit 130 receives the video 14-N. However, since the time information 12-N has not caught up with the time information 12-1, the video display unit 130 does not display the video 14-N (handles the display as completed at the presentation time of the video 14-N and discards the video 14-N).

Since the channel 100-j has the longest transmission delay, the video encoded data 11-j is received by the decoder 110-j at the latest time (0(j)). The decoder 110-j controls the clock in it based on time information included in the video encoded data 11-j. The decoder 110-j outputs the time information 12-j measured by the clock to the decoding timing control unit 120.

The decoding timing control unit 120 receives the time information 12-j from the decoder 110-j. At this time, since the decoders 110-1 and 110-N are operating, the decoding timing control unit 120 outputs, to the decoder 110-j, the decoding timing control information 13-j for operating the decoder 110-j at the ×1 speed.

The decoder 110-j receives the decoding timing control information 13-j. Based on the decoding timing control information 13-j, the decoder 110-j generates the video 14-j by decoding the video encoded data 11-j at the ×1 speed and outputs it to the video display unit 130. The video display unit 130 receives the video 14-j. However, since the time information 12-j has not caught up with the time information 12-1, the video display unit 130 does not display the video 14-j (handles the display as completed at the presentation time of the video 14-j and discards the video 14-j).

As described above, q<1. Hence, the time information 12-j catches up with the time information 12-N at a certain time (T1(N)) after the operation of the decoder 110-j. T1(N) is decided by q, the transmission delay in the channel 100-j, and that in the channel 100-N. At this time, the decoding timing control unit 120 outputs, to the decoder 110-N, the decoding timing control information 13-N for operating the decoder 110-N at the ×1 speed.

The decoder 110-N receives the decoding timing control information 13-N. Based on the decoding timing control information 13-N, the decoder 110-N generates the video 14-N by decoding the video encoded data 11-N at the ×1 speed and outputs it to the video display unit 130. The video display unit 130 receives the video 14-N. However, since the time information 12-N (equal to the time information 12-j) has not caught up with the time information 12-1, the video display unit 130 does not display the video 14-N (handles the display as completed at the presentation time of the video 14-N and discards the video 14-N).

As described above, p<1. Hence, the pieces of time information 12-j and 12-N catch up with the time information 12-1 at a certain time (T1(j)) after the operation of the decoder 110-j. T1(j) is decided by p, the transmission delay in the channel 100-1, and that in the channel 100-j. At this time, the decoding timing control unit 120 outputs, to the decoder 110-1, the decoding timing control information 13-1 for operating the decoder 110-1 at the ×1 speed.

The decoder 110-1 receives the decoding timing control information 13-1. Based on the decoding timing control information 13-1, the decoder 110-1 generates the video 14-1 by decoding the video encoded data 11-1 at the ×1 speed and outputs it to the video display unit 130. The video display unit 130 receives the video 14-1. At this time, since the decoders 110-1, 110-j, and 110-N are operating at the ×1 speed, the video display unit 130 displays the videos 14-1, 14-j, and 14-N at the ×1 speed.

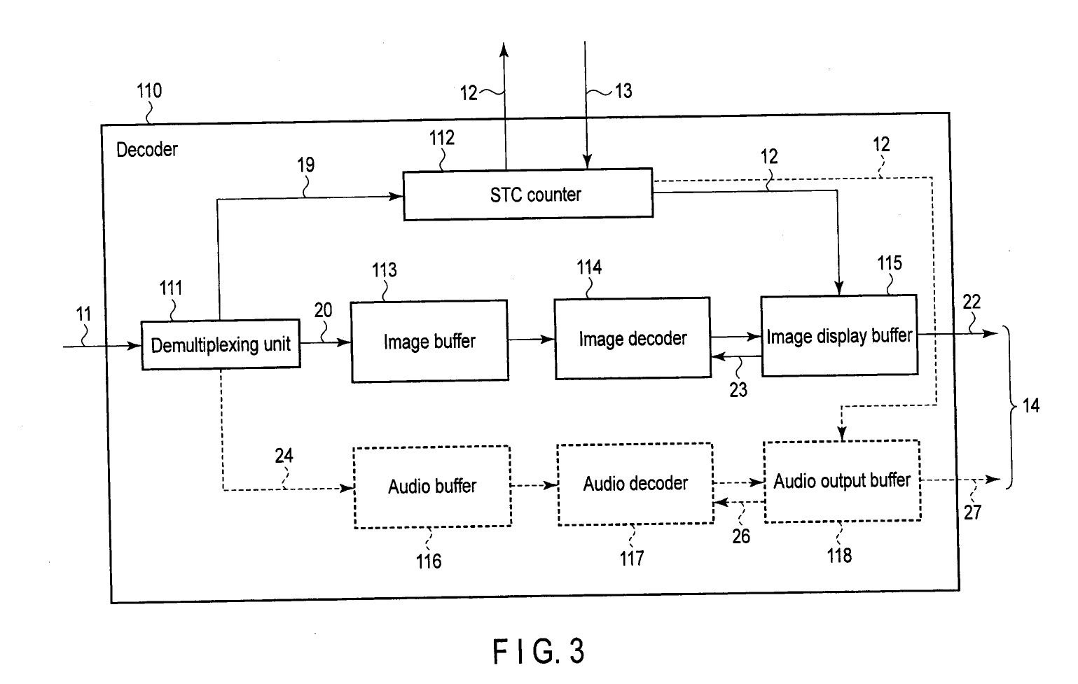

FIG. 3 shows a decoder (corresponding to, for example, the decoders 110-1, 110-j, and 110-N shown in FIG. 1) according to this embodiment. Note that the suffixes such as “-1”, “-j”, and “-N” are omitted in FIG. 3 for descriptive clarity.

The decoder 110 includes a demultiplexing unit 111, an STC counter 112, an image buffer 113, an image decoder 114, and an image display buffer 115. The decoder 110 may further include an audio buffer 116, an audio decoder 117, and an audio output buffer 118 as needed. In the following description, the decoder 110 is assumed to include the audio buffer 116, the audio decoder 117, and the audio output buffer 118.

The demultiplexing unit 111 receives the video encoded data 11 from the channel (for example, the channel 100-1, 100-j, or 100-N in FIG. 1). For example, time information 19 (for example, PCR), image encoded data 20 (corresponding to, for example, video PES (Packetized Elementary Stream), audio encoded data 24 (corresponding to, for example, audio PES), and the like are multiplexed on the video encoded data 11. The demultiplexing unit 111 divides (demultiplexes) the video encoded data 11, thereby obtaining the time information 19, the image encoded data 20, and the audio encoded data 24. The demultiplexing unit 111 outputs the time information 19 to the STC counter 112, the image encoded data 20 to the image buffer 113, and the audio encoded data 24 to the audio buffer 116.

At the time of time measurement operation, the STC counter 112 counts clocks, thereby obtaining the time information 12. The STC counter 112 outputs the time information 12 to the decoding timing control unit (for example, decoding timing control unit 120 in FIG. 1), the image display buffer 115, and the audio output buffer 118. The time measurement operation of the STC counter 112 is controlled by the time information 19 from the demultiplexing unit 111. For example, when a PCR serving as the time information 19 is input for the first time during a halt of the time measurement operation of the STC counter 112, the PCR is loaded as the initial time, and the STC counter 112 starts the time measurement operation. The STC counter 112 can also correct the time information 12 based on the PCR serving as the time information 19 input after the start of the time measurement operation.

The STC counter 112 receives the decoding timing control information 13 from the decoding timing control unit (for example, decoding timing control unit 120 in FIG. 1). The speed of the time measurement operation of the STC counter 112 is controlled by the decoding timing control information 13. The decoding timing control information 13 is used to control the operation speed of the decoder 110 to the ×1 speed or a speed lower than the ×1 speed.

According to the MPEG-2 Systems standard, the normal operation frequency of the STC counter 112 (that is, the frequency to count up the time information 12) is 27 MHz. To operate the decoder 110 at, for example, ½ speed, the operation frequency of the STC counter 112 may be changed to ½ the normal operation frequency, that is, 13.5 MHz. Alternatively, to operate the decoder 110 at, for example, ½ speed, the STC counter 112 may count up the time information 12 every two clocks.

The image buffer 113 receives the image encoded data 20 from the demultiplexing unit 111 and stores it. The image encoded data 20 stored in the image buffer 113 is read out by the image decoder 114 as needed.

The image decoder 114 reads out the image encoded data 20 stored in the image buffer 113 as needed and decodes it, thereby obtaining an image 22 and presentation time information. The image decoder 114 outputs the decoded image 22 and the presentation time information to the image display buffer 115. Note that the image decoder 114 stops decoding upon receiving a decoding pause signal 23 from the image display buffer 115.

The image display buffer 115 receives the image 22 and the presentation time information from the image decoder 114 and stores them. When the time represented by the time information 12 from the STC counter 112 reaches the time represented by the presentation time information, the image display buffer 115 outputs the image 22 corresponding to the presentation time information to the video display unit (for example, video display unit 130 in FIG. 1). The image 22 output from the image display buffer 115 is deleted from the image display buffer 115 regardless of whether it is displayed by the video display unit.

In addition, the image display buffer 115 can output the decoding pause signal 23 to the image decoder 114 based on the occupied amount. For example, when the occupied amount reaches the upper limit, the image display buffer 115 outputs the decoding pause signal 23 to the image decoder 114. This operation can prevent overflow of the image display buffer 115. Note that when the image 22 and the presentation time information are deleted from the image display buffer 115 along with the elapse of time, the occupied amount of the image display buffer 115 decreases. Hence, the image display buffer 115 cancels the decoding pause signal 23. As a result, the image decoder 114 can resume decoding of the image encoded data 20.

The audio buffer 116 receives the audio encoded data 24 from the demultiplexing unit 111 and stores it. The audio encoded data 24 stored in the audio buffer 116 is read out by the audio decoder 117 as needed.

The audio decoder 117 reads out the audio encoded data 24 stored in the audio buffer 116 as needed and decodes it, thereby obtaining audio 27 and presentation time information. The audio decoder 117 outputs the decoded audio 27 and the presentation time information to the audio output buffer 118. Note that the audio decoder 117 stops decoding upon receiving a decoding pause signal 26 from the audio output buffer 118.

The audio output buffer 118 receives the audio 27 and the presentation time information from the audio decoder 117 and stores them. When the time represented by the time information 12 from the STC counter 112 reaches the time represented by the presentation time information, the audio output buffer 118 outputs the audio 27 corresponding to the presentation time information to the video display unit (for example, video display unit 130 in FIG. 1). The audio 27 output from the audio output buffer 118 is deleted from the audio output buffer 118 regardless of whether it is output by the video display unit.

In addition, the audio output buffer 118 can output the decoding pause signal 26 to the audio decoder 117 based on the occupied amount. For example, when the occupied amount reaches the upper limit, the audio output buffer 118 outputs the decoding pause signal 26 to the audio decoder 117. This operation can prevent overflow of the audio output buffer 118. Note that when the audio 27 and the presentation time information are deleted from the audio output buffer 118 along with the elapse of time, the occupied amount of the audio output buffer 118 decreases. Hence, the audio output buffer 118 cancels the decoding pause signal 26. As a result, the audio decoder 117 can resume decoding of the audio encoded data 24.

The capacities of the image buffer 113, the image display buffer 115, the audio buffer 116, and the audio output buffer 118 are preferably decided in consideration of the transmission delay differences between the video encoded data 11 and other video encoded data. For example, the longer the period when the decoder 110 operates at a speed lower than the ×1 speed is (that is, the longer the transmission delay difference is), the larger the capacities of the image buffer 113, the image display buffer 115, the audio buffer 116, and the audio output buffer 118 may be designed.

As described above, in the video transmission scheme of transmitting video encoded data via a plurality of channels, upon receiving video encoded data via a channel having the shortest transmission delay, the video display apparatus according to the first embodiment decodes and displays the video encoded data at a speed lower than the ×1 speed. Hence, according to the video display apparatus, the video display wait time is decided by the minimum transmission delay among the plurality of channels. For example, in the examples of FIGS. 2 and 5, the video can be displayed at a timing after a predetermined processing delay from the shortest transmission delay (0(1)). This timing does not depend on the other transmission delays (0(j) and 0(N)). That is, according to the video display apparatus, it is possible to shorten the video display wait time (that is, attain almost the same video display wait time as in a case where video encoded data is received via the channel having the shortest transmission delay) in the video transmission scheme.

### Second Embodiment

In a video display apparatus according to the second embodiment, the operations of a decoding timing control unit 120 and a video display unit 130 in the video display apparatus shown in FIG. 1 are modified.

The decoding timing control unit 120 receives time information 12-1 from a decoder 110-1. Based on the operation states of the decoders (including the decoders 110-1, 110-j, and 110-N), the decoding timing control unit 120 outputs, to the decoder 110-1, decoding timing control information 13-1 for operating the decoder 110-1 at the ×1 speed or a speed lower than the ×1 speed.

More specifically, if at least one of the remaining decoders is operating at the start of the operation of the decoder 110-1, the decoding timing control unit 120 outputs, to the decoder 110-1, the decoding timing control information 13-1 for operating the decoder 110-1 at the ×1 speed. On the other hand, if all the remaining decoders are not operating at the start of the operation of the decoder 110-1, the decoding timing control unit 120 outputs, to the decoder 110-1, the decoding timing control information 13-1 for operating the decoder 110-1 at the ×p speed. Here, p is a value smaller than 1.

If time information from another decoder (to be referred to as a second decoder for simplicity of description) that is operating at the ×1 speed catches up with time information from a decoder (to be referred to as a first decoder for simplicity of description) during the operation of the first decoder at the ×p speed, the decoding timing control unit 120 determines the operation states of the decoders 110-1, . . . , 110-j, . . . , 110-N. When all decoders (including the first decoder) other than the second decoder are operating at the ×p speed, the decoding timing control unit 120 outputs, to these decoders, decoding timing control information for operating these decoders at the ×1 speed. On the other hand, when at least one decoder other than the second decoder is operating at the ×1 speed, the decoding timing control unit 120 outputs, to the second decoder, decoding timing control information for operating the second decoder at the ×p speed.

Note that in the above description, the decoder 110-1, video encoded data 11-1, the time information 12-1, and the decoding timing control information 13-1 may be replaced with the decoder 110-j, video encoded data 11-j, time information 12-j, and decoding timing control information 13-j, or the decoder 110-N, video encoded data 11-N, time information 12-N, and decoding timing control information 13-N.

The decoding timing control unit 120 can determine the operation states of the decoders 110-1, . . . , 110-j, . . . , 110-N via the pieces of time information 12-1, . . . , 12-j, . . . , 12-N. The decoding timing control unit 120 outputs decoder operation information 15 representing the operation states of the decoders 110-1, . . . , 110-j, . . . , 110-N to the video display unit 130.

The video display unit 130 receives videos 14-1, . . . , 14-j, . . . , 14-N from the decoders 110-1, . . . , 110-j, . . . , 110-N and the decoder operation information 15 from the decoding timing control unit 120. The video display unit 130 can detect the operation states of the decoders 110-1, . . . , 110-j, . . . , 110-N via the decoder operation information 15.

If all the decoders 110-1, . . . , 110-j, . . . , 110-N are operating at the ×1 speed (that is, pieces of time information from all decoders synchronize), the video display unit 130 displays the videos 14-1, . . . , 14-j, . . . , 14-N at the ×1 speed. The technique of displaying the videos 14-1, . . . , 14-j, . . . , 14-N can be the same as or similar to that in the first embodiment.

If at least one of the decoders 110-1, . . . , 110-j, . . . , 110-N is operating at the ×p speed (that is, time information from at least one decoder has not caught up with time information from other decoders that are operating at the ×p speed), the video display unit 130 displays the video from that decoder at the ×p speed.

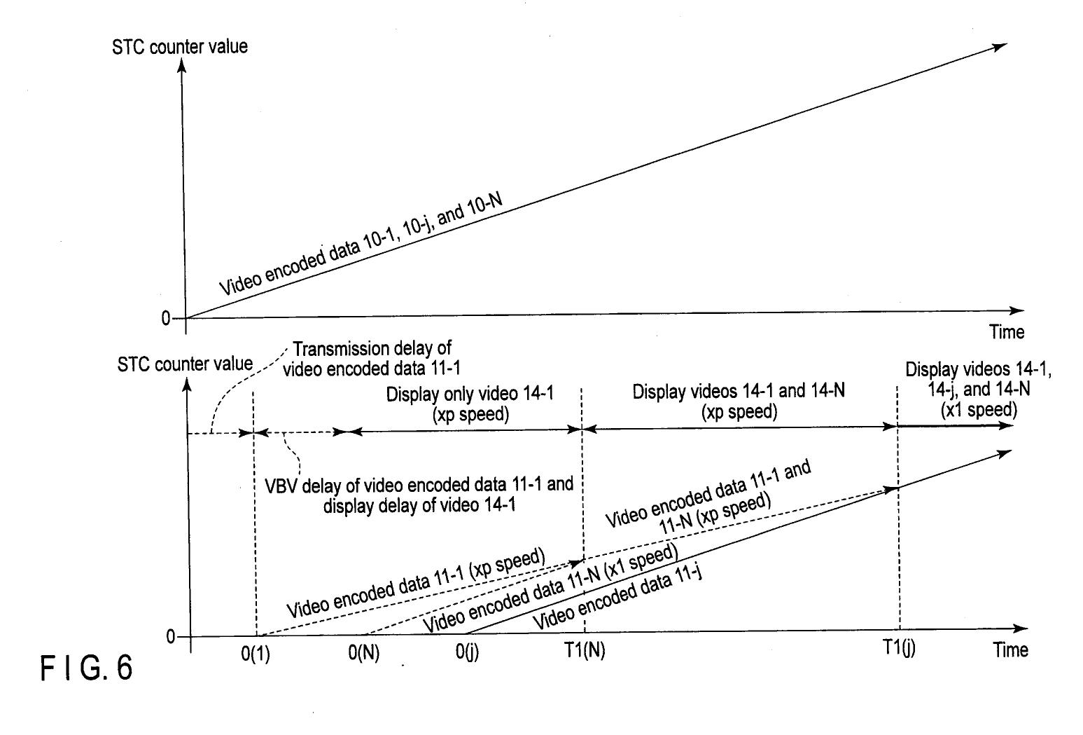

FIG. 6 shows the operation of the video display apparatus according to this embodiment. In the example of FIG. 6, video encoded data 10-1, 10-j, and 10-N have the same transmission start timing, and also have the same display timing (and output timing). In the example of FIG. 6, the display timing (and output timing) are expressed using STC counter values. Note that the video encoded data 10-1, 10-j, and 10-N may have different display timings (and output timings). In this case, for example, additional information representing the offset of the display timing (and output timing) between the video encoded data may be transmitted.

In the example of FIG. 6, assume that the video 14-1 corresponds to a video serving as a base, the video 14-N corresponds to an additional video displayed in synchronism with the video 14-1, and the video 14-j corresponds to an additional video displayed in synchronism with the videos 14-1 and 14-N. Also assume that the transmission delay in a channel 100-1 is the shortest, and the transmission delay in a channel 100-j is the longest.

Since the channel 100-1 has the shortest transmission delay, the video encoded data 11-1 is received by the decoder 110-1 at a time (0(1)) earlier than the video encoded data 11-j and 11-N. The decoder 110-1 controls the clock in it based on time information included in the video encoded data 11-1. The decoder 110-1 outputs the time information 12-1 measured by the clock to the decoding timing control unit 120.

The decoding timing control unit 120 receives the time information 12-1 from the decoder 110-1. At this time, since the decoders 110-j and 110-N are not operating, the decoding timing control unit 120 outputs, to the decoder 110-1, the decoding timing control information 13-1 for operating the decoder 110-1 at the ×p speed.

The decoder 110-1 receives the decoding timing control information 13-1. Based on the decoding timing control information 13-1, the decoder 110-1 generates the video 14-1 by decoding the video encoded data 11-1 at the ×p speed and outputs it to the video display unit 130. The video display unit 130 receives the video 14-1 and displays it. The display speed of the video 14-1 is the ×p speed because it is dependent on the operation speed of the decoder 110-1.

Since a channel 100-N has the second shortest transmission delay, the video encoded data 11-N is received by the decoder 110-N at a time (0(N)) earlier than the video encoded data 11-j. The decoder 110-N controls the clock in it based on time information included in the video encoded data 11-N. The decoder 110-N outputs the time information 12-N measured by the clock to the decoding timing control unit 120.

The decoding timing control unit 120 receives the time information 12-N from the decoder 110-N. At this time, since the decoder 110-1 is operating, the decoding timing control unit 120 outputs, to the decoder 110-N, the decoding timing control information 13-N for operating the decoder 110-N at the ×1 speed.

The decoder 110-N receives the decoding timing control information 13-N. Based on the decoding timing control information 13-N, the decoder 110-N generates the video 14-N by decoding the video encoded data 11-N at the ×1 speed and outputs it to the video display unit 130. The video display unit 130 receives the video 14-N. However, since the time information 12-N has not caught up with the time information 12-1, the video display unit 130 does not display the video 14-N (handles the display as completed at the presentation time of the video 14-N and discards the video 14-N).

Since the channel 100-j has the longest transmission delay, the video encoded data 11-j is received by the decoder 110-j at the latest time (0(j)). The decoder 110-j controls the clock in it based on time information included in the video encoded data 11-j. The decoder 110-j outputs the time information 12-j measured by the clock to the decoding timing control unit 120.

The decoding timing control unit 120 receives the time information 12-j from the decoder 110-j. At this time, since the decoders 110-1 and 110-N are operating, the decoding timing control unit 120 outputs, to the decoder 110-j, the decoding timing control information 13-j for operating the decoder 110-j at the ×1 speed.

The decoder 110-j receives the decoding timing control information 13-j. Based on the decoding timing control information 13-j, the decoder 110-j generates the video 14-j by decoding the video encoded data 11-j at the ×1 speed and outputs it to the video display unit 130. The video display unit 130 receives the video 14-j. However, since the time information 12-j has not caught up with the time information 12-1, the video display unit 130 does not display the video 14-j (handles the display as completed at the presentation time of the video 14-j and discards the video 14-j).

As described above, p<1. Hence, the time information 12-N catches up with the time information 12-1 at a certain time (T1(N)) after the operation of the decoder 110-N. T1(N) is decided by p, the transmission delay in the channel 100-1, and that in the channel 100-N. At this time, the decoding timing control unit 120 outputs, to the decoder 110-N, the decoding timing control information 13-N for operating the decoder 110-N at the ×p speed.

The decoder 110-N receives the decoding timing control information 13-N. Based on the decoding timing control information 13-N, the decoder 110-N generates the video 14-N by decoding the video encoded data 11-N at the ×p speed and outputs it to the video display unit 130. The video display unit 130 receives the video 14-N. At this time, since the decoders 110-1 and 110-N are operating at the ×p speed, and the decoder 110-j is operating at the ×1 speed, the video display unit 130 displays the videos 14-1 and 14-N at the ×p speed.

As described above, p<1. Hence, the time information 12-j catches up with the pieces of time information 12-1 and 12-N at a certain time (T1(j)) after the operation of the decoder 110-j. T1(j) is decided by p, the transmission delay in the channel 100-1, and that in the channel 100-j. At this time, the decoding timing control unit 120 outputs, to the decoders 110-1 and 110-N, the pieces of decoding timing control information 13-1 and 13-N for operating the decoders 110-1 and 110-N at the ×1 speed.

The decoders 110-1 and 110-N receive the pieces of decoding timing control information 13-1 and 13-N. Based on the pieces of decoding timing control information 13-1 and 13-N, the decoders 110-1 and 110-N generate the videos 14-1 and 14-N by decoding the video encoded data 11-1 and 11-N at the ×1 speed and output them to the video display unit 130. The video display unit 130 receives the videos 14-1 and 14-N. At this time, since the decoders 110-1, 110-j, and 110-N are operating at the ×1 speed, the video display unit 130 displays the videos 14-1, 14-j, and 14-N at the ×1 speed.

As described above, in the video transmission scheme of transmitting video encoded data via a plurality of channels, upon receiving video encoded data via a channel having the shortest transmission delay, the video display apparatus according to the second embodiment decodes and displays the video encoded data at a speed (×p speed) lower than the ×1 speed. Hence, according to the video display apparatus, the video display wait time is decided by the minimum transmission delay among the plurality of channels. For example, in the example of FIG. 6, the video can be displayed at a timing after a predetermined processing delay from the shortest transmission delay (0(1)). This timing does not depend on the other transmission delays (0(j) and 0(N)). That is, according to the video display apparatus, it is possible to shorten the video display wait time (that is, attain almost the same video display wait time as in a case where video encoded data is received via the channel having the shortest transmission delay) in the video transmission scheme.

In addition, upon receiving video encoded data via a channel whose transmission delay is not the shortest, the video display apparatus decodes the video encoded data at the ×1 speed. When the time information from the second decoder operating at the ×1 speed catches up with the time information from the first decoder operating at the ×p speed, the video display apparatus can further display a second video decoded by the second decoder in addition to a first video decoded by the first decoder. It is therefore possible to early view even a video (for example, video 14-N in FIG. 6) received via the channel whose transmission delay is not the shortest.

### Third Embodiment

In a video display apparatus according to the third embodiment, the operations of a decoding timing control unit 120 and a video display unit 130 in the video display apparatus shown in FIG. 1 are modified.

The decoding timing control unit 120 receives time information 12-1 from a decoder 110-1. Based on the operation states of the decoders (including the decoders 110-1, 110-j, and 110-N), the decoding timing control unit 120 outputs, to the decoder 110-1, decoding timing control information 13-1 for operating the decoder 110-1 at the ×1 speed or a speed lower than the ×1 speed.

More specifically, at the start of the operation of the decoder 110-1, the decoding timing control unit 120 outputs, to the decoder 110-1, the decoding timing control information 13-1 for operating the decoder 110-1 at the ×1 speed.

If the decoder 110-1 has started the operation first out of all decoders, the decoding timing control unit 120 outputs, to the decoder 110-1, the decoding timing control information 13-1 for operating (that is, stopping) the decoder 110-1 at the ×0 speed at a certain point in time. The certain point in time can be either a point in time at which the first image of a video 14-1 is displayed by the video display unit 130 or an arbitrary point in time after that.

Assume that the decoder 110-1 is the second or subsequent decoder that has started the operation out of all decoders. In this case, when the time information 12-1 has caught up with the time information from another decoder (to be referred to as a first decoder for simplicity of description) that has started the operation first, the decoding timing control unit 120 determines the operation states of the decoders 110-1, . . . , 110-j, . . . , 110-N. If pieces of time information from all decoders (including the first decoder) other than the decoder 110-1 match, the decoding timing control unit 120 outputs, to these decoders, decoding timing control information for operating these decoders at the ×1 speed. On the other hand, if time information from at least one decoder other than the decoder 110-1 does not match the time information from the first decoder, the decoding timing control unit 120 outputs, to the decoder 110-1, the decoding timing control information 13-1 for operating (that is, stopping) the decoder 110-1 at the ×0 speed.

Note that in the above description, the decoder 110-1, video encoded data 11-1, the time information 12-1, and the decoding timing control information 13-1 may be replaced with the decoder 110-j, video encoded data 11-j, time information 12-j, and decoding timing control information 13-j, or the decoder 110-N, video encoded data 11-N, time information 12-N, and decoding timing control information 13-N.

The decoding timing control unit 120 can determine the operation states of the decoders 110-1, . . . , 110-j, . . . , 110-N via the pieces of time information 12-1, . . . , 12-j, . . . , 12-N. The decoding timing control unit 120 outputs decoder operation information 15 representing the operation states of the decoders 110-1, . . . , 110-j, . . . , 110-N to the video display unit 130.

The video display unit 130 receives the videos 14-1, . . . , 14-j, . . . , 14-N from the decoders 110-1, . . . , 110-j, . . . , 110-N and the decoder operation information 15 from the decoding timing control unit 120. The video display unit 130 can detect the operation states of the decoders 110-1, . . . , 110-j, . . . , 110-N via the decoder operation information 15.

If all the decoders 110-1, . . . , 110-j, . . . , 110-N are operating at the ×1 speed (that is, pieces of time information from all decoders synchronize), the video display unit 130 displays the videos 14-1, . . . , 14-j, . . . , 14-N at the ×1 speed. The technique of displaying the videos 14-1, . . . , 14-j, . . . , 14-N can be the same as or similar to that in the first embodiment.

If one of the decoders 110-1, . . . , 110-j, . . . , 110-N, which has first started the operation, is operating at the ×1 speed before the stop, the video display unit 130 displays the video from that decoder at the ×1 speed.

If at least one of the decoders 110-1, . . . , 110-j, . . . , 110-N has stopped after the start of the operation, the video display unit 130 displays the video from that decoder at the ×0 speed (for example, displays the video as a still image).

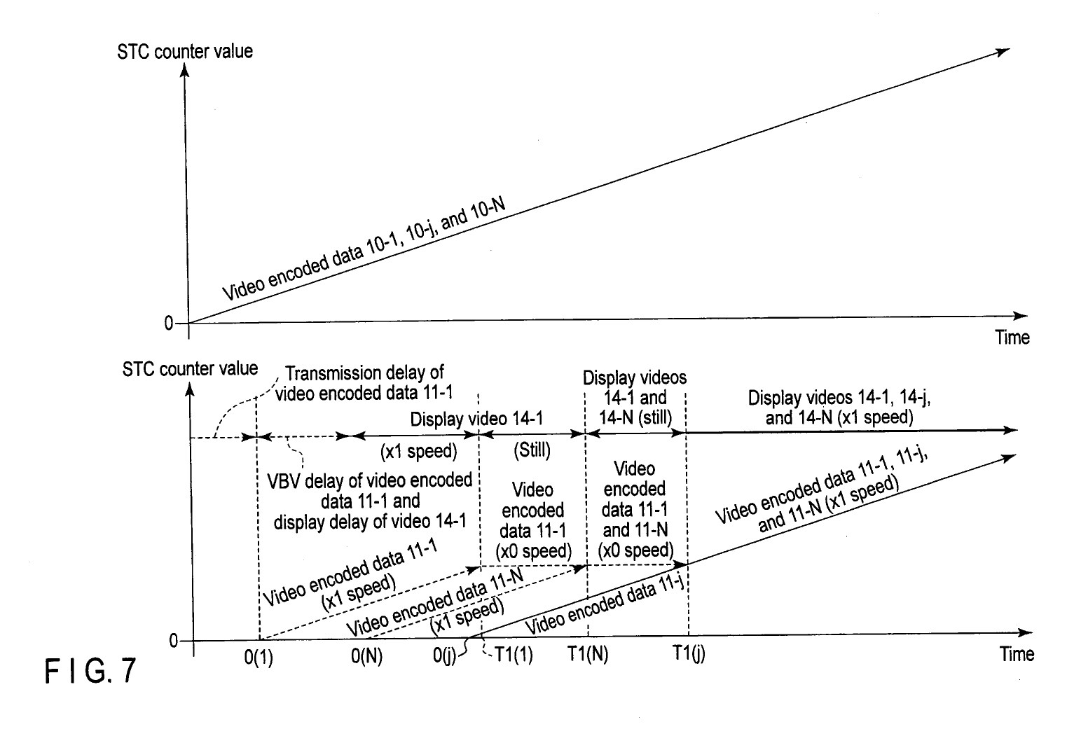

FIG. 7 shows the operation of the video display apparatus according to this embodiment. In the example of FIG. 7, video encoded data 10-1, 10-j, and 10-N have the same transmission start timing, and also have the same display timing (and output timing). In the example of FIG. 7, the display timing (and output timing) are expressed using STC counter values. Note that the video encoded data 10-1, 10-j, and 10-N may have different display timings (and output timings). In this case, for example, additional information representing the offset of the display timing (and output timing) between the video encoded data may be transmitted.

In the example of FIG. 7, assume that the video 14-1 corresponds to a video serving as a base, the video 14-N corresponds to an additional video displayed in synchronism with the video 14-1, and the video 14-j corresponds to an additional video displayed in synchronism with the videos 14-1 and 14-N. Also assume that the transmission delay in a channel 100-1 is the shortest, and the transmission delay in a channel 100-j is the longest.

Since the channel 100-1 has the shortest transmission delay, the video encoded data 11-1 is received by the decoder 110-1 at a time (0(1)) earlier than the video encoded data 11-j and 11-N. The decoder 110-1 controls the clock in it based on time information included in the video encoded data 11-1. The decoder 110-1 outputs the time information 12-1 measured by the clock to the decoding timing control unit 120.

The decoding timing control unit 120 receives the time information 12-1 from the decoder 110-1. At this time, the decoding timing control unit 120 outputs, to the decoder 110-1, the decoding timing control information 13-1 for operating the decoder 110-1 at the ×1 speed.

The decoder 110-1 receives the decoding timing control information 13-1. Based on the decoding timing control information 13-1, the decoder 110-1 generates the video 14-1 by decoding the video encoded data 11-1 at the ×1 speed and outputs it to the video display unit 130. The video display unit 130 receives the video 14-1 and displays it. The display speed of the video 14-1 is the ×1 speed because it is dependent on the operation speed of the decoder 110-1.

Since the decoder 110-1 has started the operation first out of all decoders, the decoding timing control unit 120 outputs, to the decoder 110-1, the decoding timing control information 13-1 for operating the decoder 110-1 at the ×0 speed at a predetermined timing (T1(1)). In addition, since the decoder 110-1 has stopped after the start of the operation, the video display unit 130 displays the video 14-1 at the ×0 speed.

Since a channel 100-N has the second shortest transmission delay, the video encoded data 11-N is received by the decoder 110-N at a time (0(N)) earlier than the video encoded data 11-j. The decoder 110-N controls the clock in it based on time information included in the video encoded data 11-N. The decoder 110-N outputs the time information 12-N measured by the clock to the decoding timing control unit 120.

The decoding timing control unit 120 receives the time information 12-N from the decoder 110-N. At this time, the decoding timing control unit 120 outputs, to the decoder 110-N, the decoding timing control information 13-N for operating the decoder 110-N at the ×1 speed.

The decoder 110-N receives the decoding timing control information 13-N. Based on the decoding timing control information 13-N, the decoder 110-N generates the video 14-N by decoding the video encoded data 11-N at the ×1 speed and outputs it to the video display unit 130. The video display unit 130 receives the video 14-N. However, since the time information 12-N has not caught up with the time information 12-1, the video display unit 130 does not display the video 14-N (handles the display as completed at the presentation time of the video 14-N and discards the video 14-N).

Since the channel 100-j has the longest transmission delay, the video encoded data 11-j is received by the decoder 110-j at the latest time (0(j)). The decoder 110-j controls the clock in it based on time information included in the video encoded data 11-j. The decoder 110-j outputs the time information 12-j measured by the clock to the decoding timing control unit 120.

The decoding timing control unit 120 receives the time information 12-j from the decoder 110-j. At this time, the decoding timing control unit 120 outputs, to the decoder 110-j, the decoding timing control information 13-j for operating the decoder 110-j at the ×1 speed.

The decoder 110-j receives the decoding timing control information 13-j. Based on the decoding timing control information 13-j, the decoder 110-j generates the video 14-j by decoding the video encoded data 11-j at the ×1 speed and outputs it to the video display unit 130. The video display unit 130 receives the video 14-j. However, since the time information 12-j has not caught up with the time information 12-1, the video display unit 130 does not display the video 14-j (handles the display as completed at the presentation time of the video 14-j and discards the video 14-j).

As described above, the decoder 110-1 has stopped. Hence, the time information 12-N catches up with the time information 12-1 at a certain time (T1(N)) after the operation of the decoder 110-N. T1(N) is decided by the transmission delay in the channel 100-1 and that in the channel 100-N. At this time, since the time information 12-j has not caught up with the time information 12-1, the decoding timing control unit 120 outputs, to the decoder 110-N, the decoding timing control information 13-N for operating the decoder 110-N at the ×0 speed. In addition, since the decoders 110-1 and 110-N have stopped after the start of the operation, the video display unit 130 displays the videos 14-1 and 14-N at the ×0 speed.

As described above, the decoders 110-1 and 110-N have stopped. Hence, the time information 12-j catches up with the pieces of time information 12-1 and 12-N at a certain time (T1(j)) after the operation of the decoder 110-j. T1(j) is decided by the transmission delay in the channel 100-1 and that in the channel 100-j. At this time, since the pieces of time information 12-1 and 12-N match, the decoding timing control unit 120 outputs, to the decoders 110-1 and 110-N, the pieces of decoding timing control information 13-1 and 13-N for operating the decoders 110-1 and 110-N at the ×1 speed.

The decoders 110-1 and 110-N receive the pieces of decoding timing control information 13-1 and 13-N. Based on the pieces of decoding timing control information 13-1 and 13-N, the decoders 110-1 and 110-N generate the videos 14-1 and 14-N by decoding the video encoded data 11-1 and 11-N at the ×1 speed and output them to the video display unit 130. The video display unit 130 receives the videos 14-1 and 14-N. At this time, since the decoders 110-1, 110-j, and 110-N are operating at the ×1 speed, the video display unit 130 displays the videos 14-1, 14-j, and 14-N at the ×1 speed.

As described above, in the video transmission scheme of transmitting video encoded data via a plurality of channels, upon receiving video encoded data via a channel having the shortest transmission delay, the video display apparatus according to the third embodiment decodes and displays the video encoded data at the ×1 speed. Hence, according to the video display apparatus, the video display wait time is decided by the minimum transmission delay among the plurality of channels. For example, in the example of FIG. 7, the video can be displayed at a timing after a predetermined processing delay from the shortest transmission delay (0(1)). This timing does not depend on the other transmission delays (0(j) and 0(N)). That is, according to the video display apparatus, it is possible to shorten the video display wait time (that is, attain almost the same video display wait time as in a case where video encoded data is received via the channel having the shortest transmission delay) in the video transmission scheme.

In addition, upon receiving video encoded data via a channel whose transmission delay is not the shortest, the video display apparatus decodes the video encoded data at the ×1 speed. When the time information from the second decoder operating at the ×1 speed catches up with the time information from the first decoder at a halt, the video display apparatus can further display the second video (for example, as a still image) decoded by the second decoder in addition to the first video decoded by the first decoder. It is therefore possible to early view even a video (for example, video 14-N in FIG. 7) received via the channel whose transmission delay is not the shortest.

Furthermore, the video display apparatus stops, at a certain point in time, decoding and display of video encoded data received via the channel having the shortest transmission delay. After the pieces of time information from all decoders match, the video display apparatus resumes decoding and display of the video encoded data. Hence, according to the video display apparatus, the decoder that receives video encoded data from the channel having the longest transmission delay can quickly synchronize with other decoders. That is, it is possible to display all videos early.

### Fourth Embodiment

A video display apparatus according to the fourth embodiment differs in the details of a decoder from the video display apparatuses according to the first to third embodiments. The operation of the video display apparatus according to the fourth embodiment can be the same as or similar to that of the video display apparatuses according to the first to third embodiments.

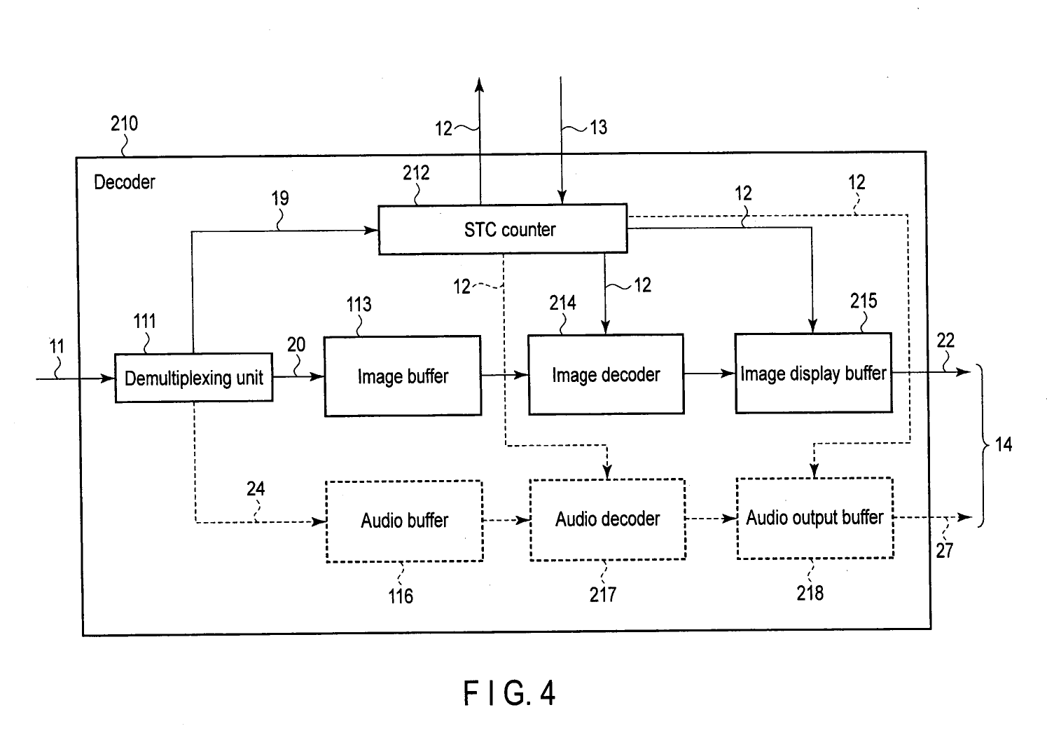

FIG. 4 shows a decoder according to this embodiment. Note that the suffixes such as “-1”, “-j”, and “-N” are omitted in FIG. 4 for descriptive clarity. A decoder 210 includes a demultiplexing unit 111, an STC counter 212, an image buffer 113, an image decoder 214, and an image display buffer 215. The decoder 210 may further include an audio buffer 116, an audio decoder 217, and an audio output buffer 218 as needed. In the following description, the decoder 210 is assumed to include the audio buffer 116, the audio decoder 217, and the audio output buffer 218. The demultiplexing unit 111, the image buffer 113, and the audio buffer 116 shown in FIG. 4 are the same as or similar to those shown in FIG. 3.

At the time of time measurement operation, the STC counter 212 counts clocks, thereby obtaining time information 12. The STC counter 212 outputs the time information 12 to a decoding timing control unit (for example, decoding timing control unit 120 in FIG. 1), the image decoder 214, the image display buffer 215, the audio decoder 217, and the audio output buffer 218. The time measurement operation of the STC counter 212 is controlled by time information 19 from the demultiplexing unit 111. For example, when a PCR serving as the time information 19 is input for the first time during a halt of the time measurement operation of the STC counter 212, the PCR is loaded as the initial time, and the STC counter 212 starts the time measurement operation. The STC counter 212 can also correct the time information 12 based on the PCR serving as the time information 19 input after the start of the time measurement operation.

The STC counter 212 receives decoding timing control information 13 from the decoding timing control unit (for example, decoding timing control unit 120 in FIG. 1). The speed of the time measurement operation of the STC counter 212 is controlled by the decoding timing control information 13.

According to the MPEG-2 Systems standard, the normal operation frequency of the STC counter 212 (that is, the frequency to count up the time information 12) is 27 MHz. To operate the decoder 210 at, for example, ½ speed, the operation frequency of the STC counter 212 may be changed to ½ the normal operation frequency, that is, 13.5 MHz. Alternatively, to operate the decoder 210 at, for example, ½ speed, the STC counter 212 may count up the time information 12 every two clocks.

The image decoder 214 reads out image encoded data 20 stored in the image buffer 113 as needed and decodes it, thereby obtaining an image 22 and presentation time information. More specifically, when the time represented by the time information 12 from the STC counter 212 reaches the time represented by decoding time information (DTS: Decoding Time Stamp), the image decoder 214 decodes the image encoded data 20 corresponding to the DTS. The DTS is encoded for each decoding unit (for example, frame or field) or estimated based on a past decoding result. The image decoder 214 outputs the decoded image 22 and the presentation time information to the image display buffer 215.

The image display buffer 215 receives the image 22 and the presentation time information from the image decoder 214 and stores them. When the time represented by the time information 12 from the STC counter 212 reaches the time represented by the presentation time information, the image display buffer 215 outputs the image 22 corresponding to the presentation time information to a video display unit (for example, video display unit 130 in FIG. 1). The image 22 output from the image display buffer 215 is deleted from the image display buffer 215 regardless of whether it is displayed by the video display unit.

The audio decoder 217 reads out audio encoded data 24 stored in the audio buffer 116 as needed and decodes it, thereby obtaining audio 27 and presentation time information. More specifically, when the time represented by the time information 12 from the STC counter 212 reaches the time represented by PTS (Presentation Time Stamp), the audio decoder 217 decodes the audio encoded data 24 corresponding to the PTS. Note that according to the MPEG-2 Systems standard, PTS can be regarded as DTS. The PTS is encoded for each decoding unit (for example, audio frame) or estimated based on a past decoding result. The audio decoder 217 outputs the decoded audio 27 and the presentation time information to the audio output buffer 218.

The audio output buffer 218 receives the audio 27 and the presentation time information from the audio decoder 217 and stores them. When the time represented by the time information 12 from the STC counter 212 reaches the time represented by the presentation time information, the audio output buffer 218 outputs the audio 27 corresponding to the presentation time information to the video display unit (for example, video display unit 130 in FIG. 1). The audio 27 output from the audio output buffer 218 is deleted from the audio output buffer 218 regardless of whether it is output by the video display unit.

The capacities of the image buffer 113 and the audio buffer 116 are preferably decided in consideration of the transmission delay differences and encoding delay differences between the video encoded data 11 and other video encoded data, jitter of the transmission delay of each channel, and the like. For example, the longer the period when the decoder 210 operates at a speed lower than the ×1 speed is (that is, the longer the transmission delay difference is), the larger the capacities of the image buffer 113 and the audio buffer 116 may be designed.

If the jitter is larger than that considered, the image buffer 113 and the audio buffer 116 may temporarily cause overflow or underflow. For example, when the image buffer 113 and the audio buffer 116 may cause underflow, the video may be displayed at a speed lower than the ×1 speed to prevent the underflow. On the other hand, when the image buffer 113 and the audio buffer 116 may cause overflow, the video may be displayed at a speed higher than the ×1 speed to prevent the overflow. Whether the image buffer 113 and the audio buffer 116 may cause underflow or overflow can be determined based on, for example, the occupied amounts of these buffers, changes in the occupied amounts, or the like.

To sum up, the decoder 210 shown in FIG. 4 is different from the decoder 110 shown in FIG. 3 in the following points.

In the decoder 110 shown in FIG. 3, the operation speeds of the image decoder 114 and the audio decoder 117 are not directly controlled by the time information 12. However, the speeds to delete the image 22 and the audio 27 from the image display buffer 115 and the audio output buffer 118 are controlled by the time information 12 and the presentation time information (and presentation time information). In addition, the image display buffer 115 and the audio output buffer 118 output decoding pause signals 23 and 26 to the image decoder 114 and the audio decoder 117 based on the occupied amounts. Hence, the operation speeds of the image decoder 114 and the audio decoder 117 are indirectly controlled by the time information 12. On the other hand, in the decoder 210 shown in FIG. 4, the operation speeds of the image decoder 214 and the audio decoder 217 are controlled by the time information 12 and the decoding time information.

As described above, in the video display apparatus according to the fourth embodiment, the operation speeds of the image decoder and the audio decoder are controlled by the decoding time information and the time information from the STC counter. Hence, according to the video display apparatus, the video display buffer and the audio output buffer do not need a function of outputting the decoding pause signal. In addition, the video display apparatus performs the same or similar operation as in the above-described first to third embodiment, thereby obtaining the same or similar effects as in these embodiments.

Note that in the above-described first to fourth embodiments, the video display apparatus displays all videos at the ×1 speed after the pieces of time information of all decoders synchronize. However, if some channels have poor quality (for example, the transmission error rate is very high, or the transmission delay is very long), a long time is needed until the pieces of time information of all decoders synchronize, which hinders video viewing. To prevent this, for example, if the quality of a channel falls below a threshold, the video display apparatus may temporarily neglect video encoded data from the channel. That is, when the pieces of time information of all decoders other than the decoder that receives video encoded data from the low-quality channel synchronize, the video display apparatus may display the videos from these decoders at the ×1 speed. Note that if the quality of the neglected channel improves and enables normal reception after this operation, the video display apparatus may return the decoder that receives video encoded data from the channel to the subject of synchronization.

### Fifth Embodiment

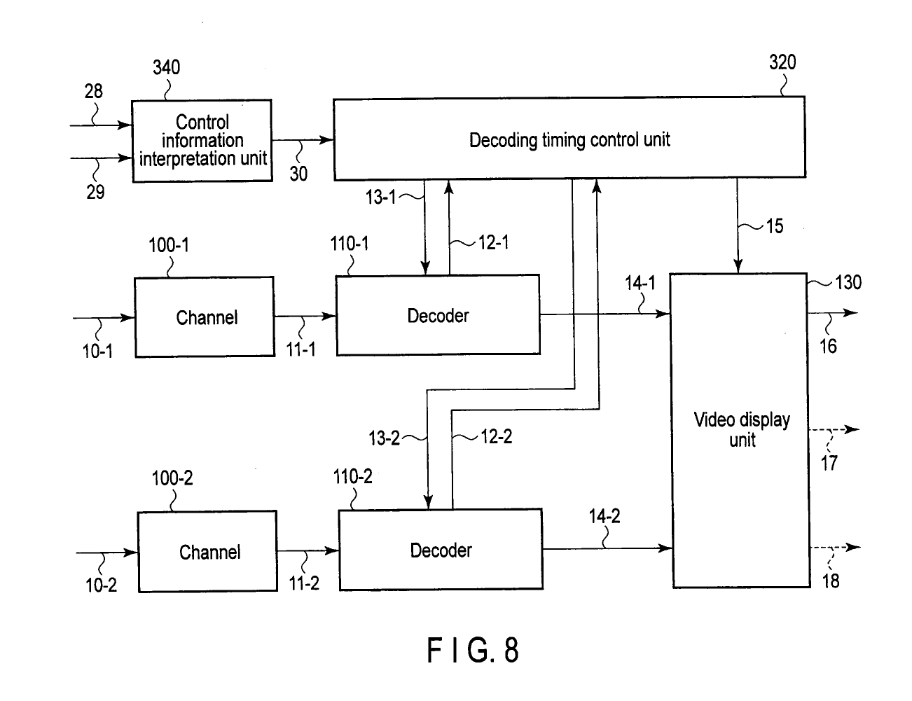

As shown in FIG. 8, a video display apparatus according to the fifth embodiment includes two decoders, 110-1 and 110-2, a decoding timing control unit 320, a video display unit 130, and a control information interpretation unit 340. The video display apparatus shown in FIG. 8 can synchronously decode and display video encoded data transmitted via two different channels, 100-1 and 100-2. Note that the number of channels is two in the example of FIG. 8 but may be three or more.

The control information interpretation unit 340 receives at least one of user information 28 and display control information 29. The control information interpretation unit 340 interprets at least one of the user information 28 and the display control information 29, thereby obtaining control information 30 concerning the display states of videos 14-1 and 14-2. The control information interpretation unit 340 outputs the control information 30 to the decoding timing control unit 320.

The user information 28 can be either operation information from the user or attribute information of the user. For example, the operation information from the user can be either an instruction to synchronously display the videos 14-1 and 14-2 or an instruction to end display of one of the videos 14-1 and 14-2.

The operation information from the user may be an instruction to select, from a plurality of videos (also called subcontent) other than the video 14-1, a piece of subcontent to be displayed in synchronism with the video 14-1 or an instruction to select a piece of subcontent not to be displayed. The control information interpretation unit 340 may present the user with information (for example, GUI (Graphical User Interface)) for accepting a user operation corresponding to the instruction to select a piece of subcontent.

The video display apparatus can either receive all subcontent regardless of which piece of subcontent is to be selected for synchronous display or request a transmission apparatus (not shown) to transmit a piece of subcontent every time a piece of subcontent to be synchronously displayed is selected. The plurality of pieces of subcontent can be transmitted either via a single channel or via different channels. To display a plurality of pieces of subcontent in synchronism with the video 14-1, the decoding timing control unit 320 adjusts the operation speed of each decoder based on the channel having the longest transmission delay, as described in the first to third embodiments above. Until a piece of subcontent received via the channel having the longest transmission delay synchronizes with the video 14-1, the other subcontent can be either discarded or displayed in synchronism with the video 14-1 after catching up with the video 14-1.

The attribute information of the user can include, for example, a user profile such as the user's age, gender, hobby, taste, past viewing history, and past purchase history. The attribute information of the user may also include present viewer composition information (for example, information representing the relationship between a plurality of users such as the number of viewers, age composition, and gender composition). Based on the attribute information of the user, the control information interpretation unit 340 can either automatically select a piece of subcontent to be displayed in synchronism with the video 14-1 or automatically select a piece of subcontent not to be displayed from a plurality of pieces of subcontent other than the video 14-1.

The display control information 29 is control information explicitly or implicitly attached to a piece of content (that is, video encoded data transmitted via at least one of the channels 100-1 and 100-2). For example, the display control information 29 can include information representing the time at which the video 14-2 is to be displayed in synchronism with the video 14-1. The decoding timing control unit 320 receives the control information 30 from the control information interpretation unit 340. Based on the control information 30, the decoding timing control unit 320 can either control the decoders 110-1 and 110-2 to synchronously display the videos 14-1 and 14-2 or control the decoders 110-1 and 110-2 to end display of one of the videos 14-1 and 14-2. More specifically, the decoding timing control unit 320 receives pieces of time information 12-1 and 12-2 from the decoders 110-1 and 110-2, and outputs, to the decoders 110-1 and 110-2, pieces of decoding timing control information 13-1 and 13-2 for operating the decoders 110-1 and 110-2 at appropriate speeds (decided by the control information 30, the transmission delay difference between the channels 100-1 and 100-2, and the like).

For example, assume that the control information 30 for instructing to synchronously display the videos 14-1 and 14-2 is input when the video 14-1 is displayed but the video 14-2 is not displayed, and the time information 12-2 lags behind the time information 12-1. At this time, the decoding timing control unit 320 may operate the decoder 110-1 at a speed lower than the ×1 speed until the pieces of time information 12-1 and 12-2 synchronize.

Note that when the video 14-1 corresponds to a specific situation, for example, a scene change, blackout, or silence, display of the video 14-1 may be paused. In the video 14-1 corresponding to the specific situation, the user can hardly perceive a change of the display period. Hence, when display of the video 14-1 is paused during the specific situation, the display delay of the video 14-1 can be made long while suppressing a sense of incongruity felt by the user.

When the decoding timing control unit 320 operates the decoder 110-1 at a speed lower than the ×1 speed, the speed need not be constant. The operation speed of the decoder 110-1 may change stepwise, for example, ×1→×0.9→×0.8×→×0.9×1. When the operation speed of the decoder 110-1 is changed stepwise, the display delay of the video 14-1 can be made long while suppressing a sense of incongruity felt by the user.

Upon receiving the control information 30 for instructing to end display of the video 14-2 when the videos 14-1 and 14-2 are synchronously being displayed, the decoding timing control unit 320 can either stop the operation of the decoder 110-2 or cause the video display unit 130 to discard the video 14-2 while maintaining the operation of the decoder 110-2. When the transmission delay of the channel 100-2 is longer than that of the channel 100-1, the display delay when displaying the video 14-1 alone can be made shorter than that when synchronously displaying the videos 14-1 and 14-2. Hence, the decoding timing control unit 320 may operate the decoder 110-1 at a speed higher than the ×1 speed to make the display delay of the video 14-1 short.

Note that when the video 14-1 corresponds to a specific situation, for example, a scene change, blackout, or silence, display of the video 14-1 may be skipped. In the video 14-1 corresponding to the specific situation, the user can hardly perceive a change of the display period. Hence, when display of the video 14-1 is skipped during the specific situation, the display delay of the video 14-1 can be made short while suppressing a sense of incongruity felt by the user.

When the decoding timing control unit 320 operates the decoder 110-1 at a speed higher than the ×1 speed, the speed need not be constant. The operation speed of the decoder 110-1 may change stepwise, for example, ×1→×1.1→×1.2→×1.1→×1. When the operation speed of the decoder 110-1 is changed stepwise, the display delay of the video 14-1 can be made short while suppressing a sense of incongruity felt by the user.

The decoding timing control unit 320 can determine the operation states of the decoders 110-1 and 110-2 based on the control information 30 and the current display states (they can be determined based on the pieces of time information 12-1 and 12-2) of the videos 14-1 and 14-2. The decoding timing control unit 320 outputs decoder operation information 15 representing the operation states of the decoders 110-1 and 110-2 to the video display unit 130.

The video display unit 130 receives the videos 14-1 and 14-2 from the decoders 110-1 and 110-2 and the decoder operation information 15 from the decoding timing control unit 320. The video display unit 130 can detect the operation states of the decoders 110-1 and 110-2 via the decoder operation information 15. When both the decoders 110-1 and 110-2 are operating at the ×1 speed, and the videos 14-1 and 14-2 need to be synchronously displayed, the video display unit 130 operates in the following way.

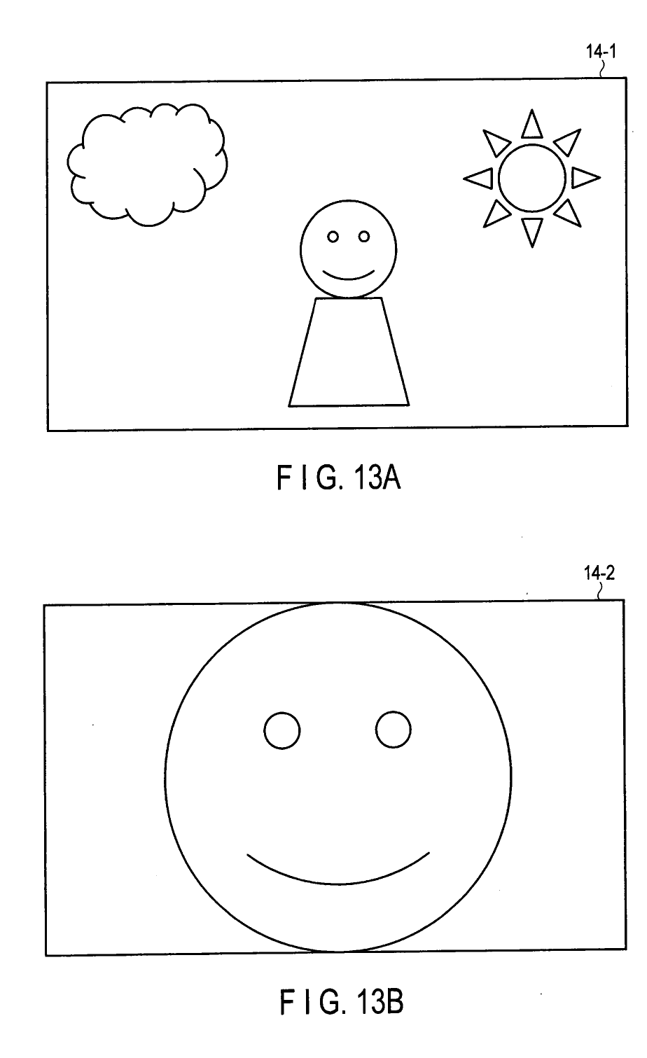

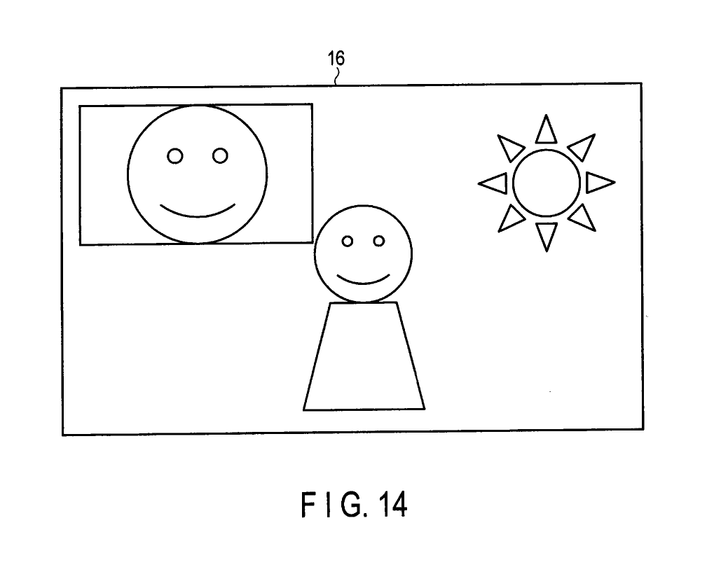

For example, the video display unit 130 displays an image 16 generated by combining images included in some of the videos 14-1 and 14-2. Combining images can be done by either overlay or blending. More specifically, the video display unit 130 may generate the image 16 (FIG. 14) that displays an image (FIG. 13A) included in the video 14-1 and an image (FIG. 13B) included in the video 14-2 in a picture-in-picture mode. According to the example of FIG. 14, the user can simultaneously view the video 14-1 and the video 14-2 shot at an angle or an angle of view different from the video 14-1.

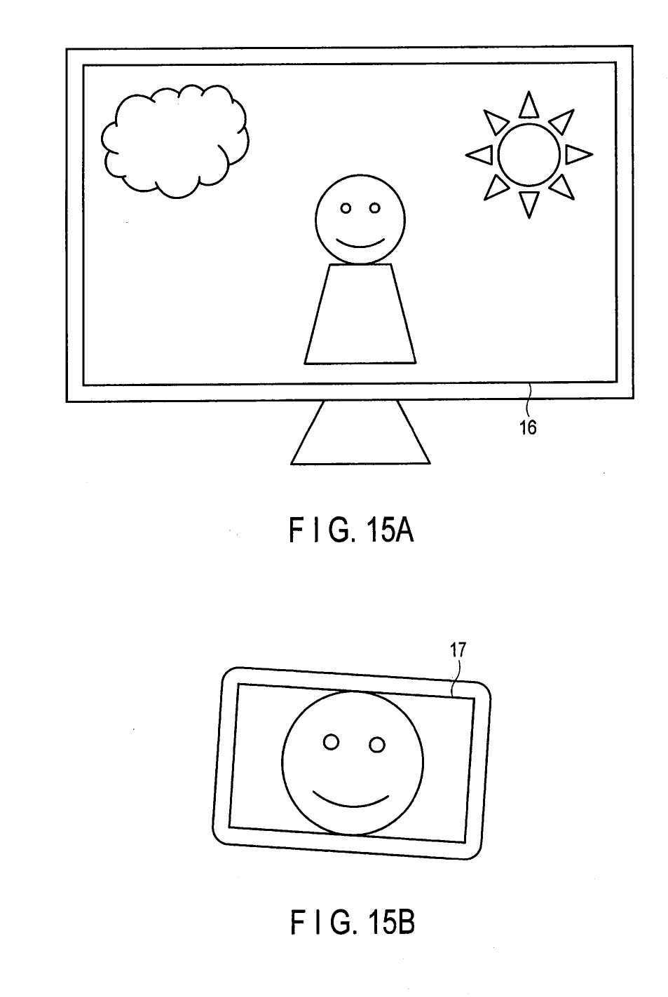

The video display unit 130 may display the image 16 (FIG. 15A) based on the image (FIG. 13A) included in the video 14-1 and a subimage 17 (FIG. 15B) based on the image (FIG. 13B) included in the video 14-2. The subimage 17 is an image for multidisplay and is displayed on a subdisplay (for example, tablet terminal or smartphone) different from the display (for example, TV) used to display the image 16.

The video display unit 130 may also output audio 18 based on pieces of audio included in some or all of the videos 14-1 and 14-2. The pieces of audio included in some of the videos 14-1 and 14-2 may be used to extend the number of surround channels.

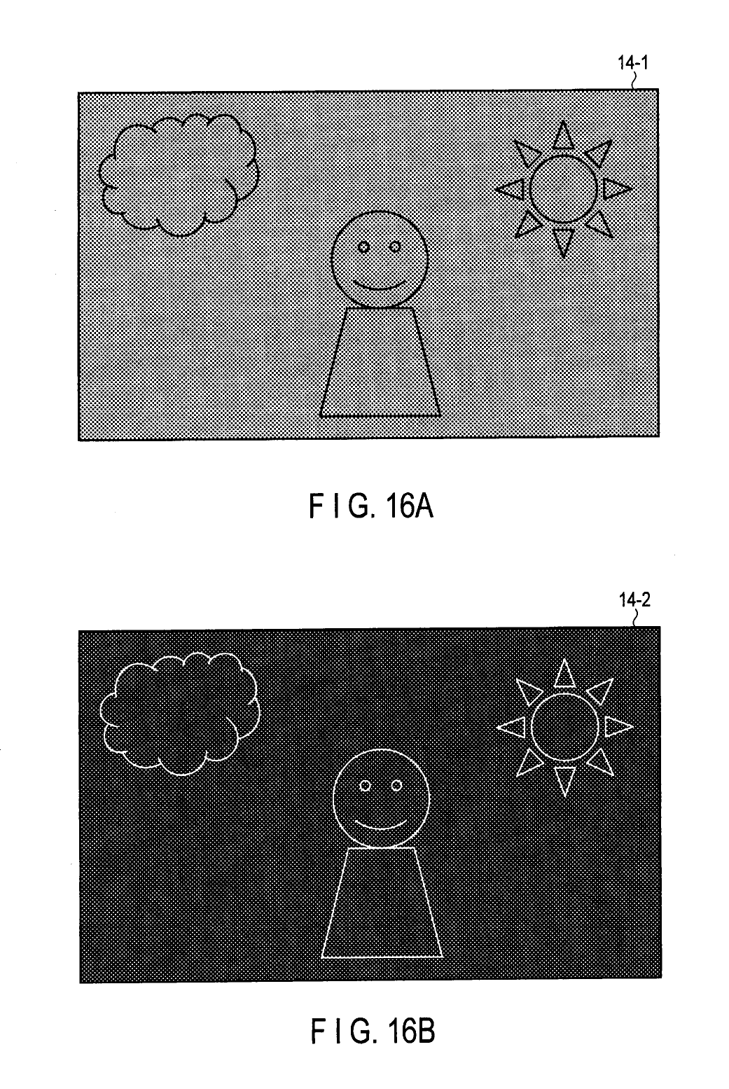

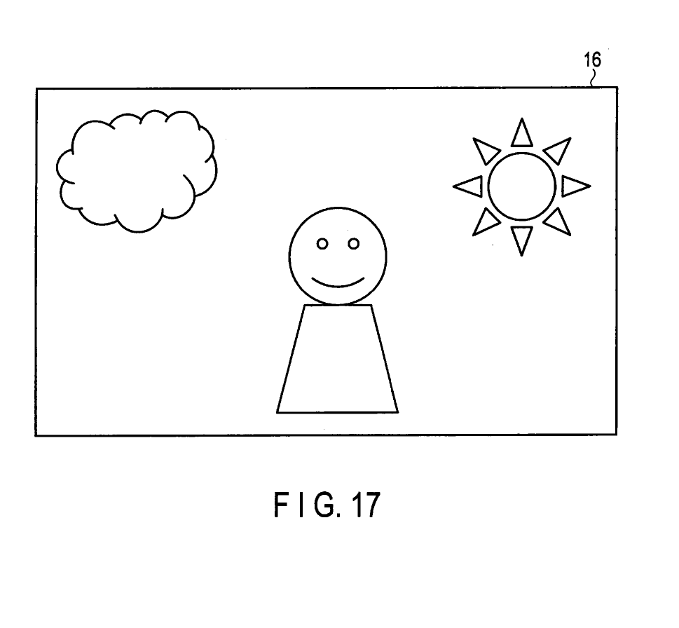

The video display unit 130 may generate the one image 16 (FIG. 17) by adding the image (FIG. 16A) included in the video 14-1 and the image (FIG. 16B) included in the video 14-2. According to the example of FIG. 17, the quality, resolution, color gamut, frame rate, and the like of the image 16 can be improved as compared to a case where the image included in the video 14-1 is directly displayed as the image 16. Note that if the images shown in FIGS. 16A and 16B have different resolutions, the video display unit 130 may generate one image 16 by equalizing the numbers of pixels of these images and adding the images on a pixel basis or by adding the images on a pixel basis without equalizing the numbers of pixels.

For example, when broadcasting a soccer game, the camera sometimes zooms up a player to show viewers the player's expression and the like under a limited resolution. If the shooting range of the image included in the video 14-2 is wider than the shooting range of the image included in the video 14-1, the video display unit 130 synchronously displays them, thereby generating the image 16 having the same shooting range as the image included in the video 14-2 without degradation of the quality, resolution, color gamut, frame rate, and the like of the image included in the video 14-1. That is, the user can view a peripheral portion (for example, the situation around the player zoomed up in the broadcast of the soccer game) that is not included in the video 14-1 as well as the content of the video 14-1. Note that a region outside of the video 14-2 where the shooting range overlaps that of the video 14-1 can be either replaced with difference information or displayed as blank (in this case, the video 14-1 may be inset in the region).

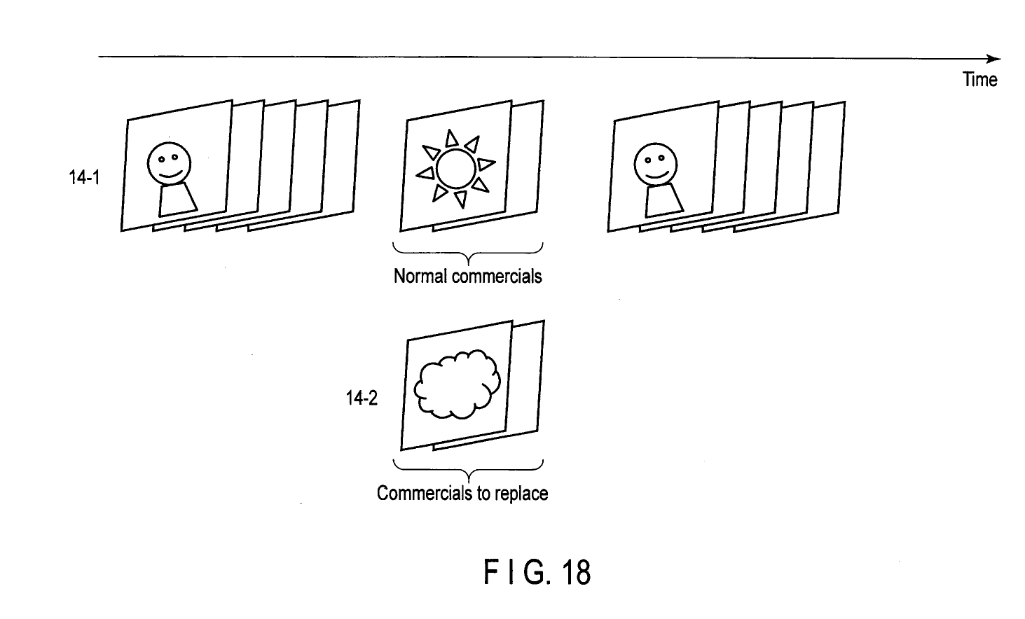

As shown in FIG. 18, when the video 14-1 is a program content including a commercial, the video 14-2 may be a commercial that replaces it. When the video display unit 130 synchronously displays the videos 14-1 and 14-2 during the commercial display period as needed (for example, displays the image 16 based on the image included in the video 14-2 in place of the video 14-1), the user can selectively view a desired commercial.

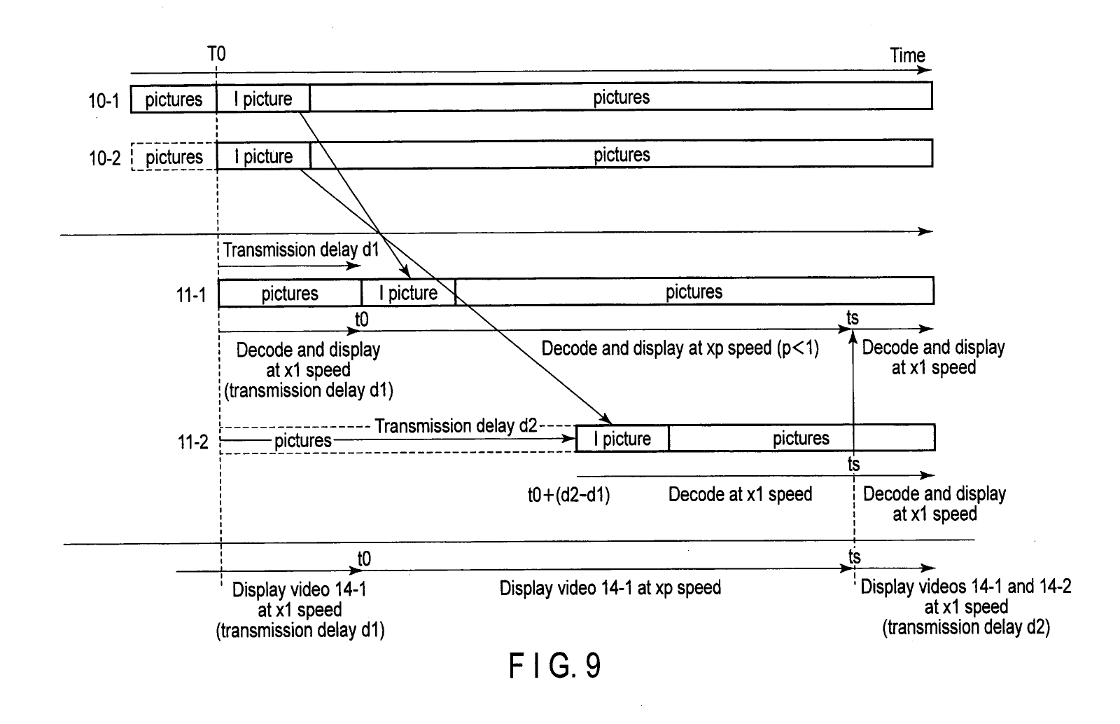

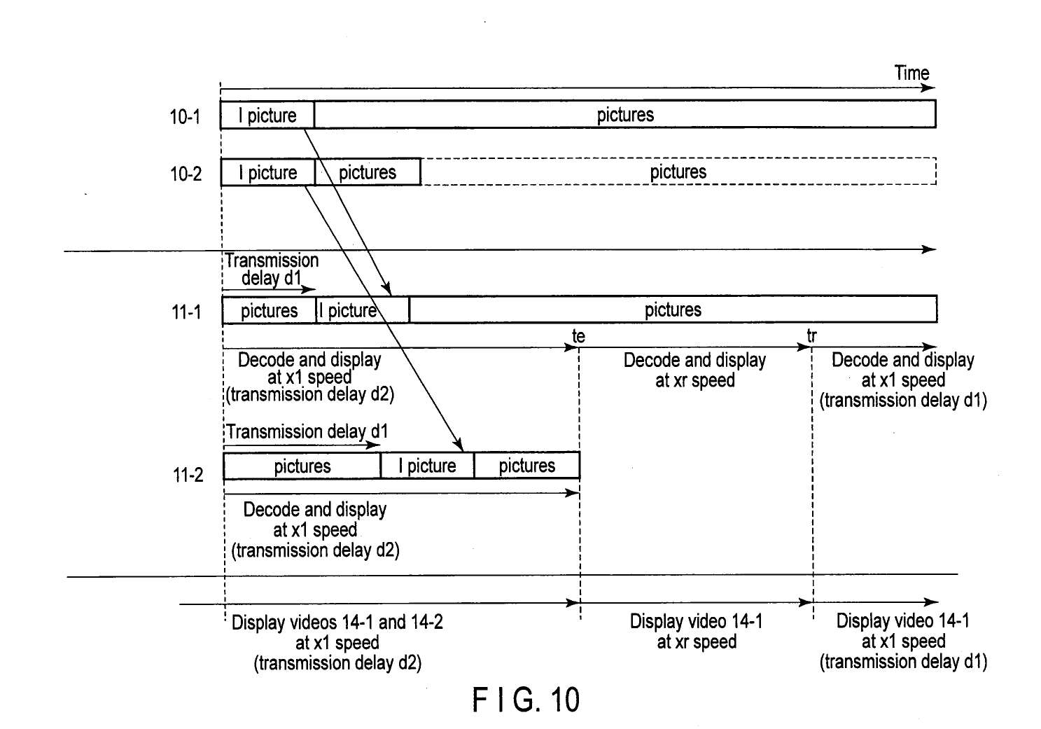

FIGS. 9 and 10 show the operation of the video display apparatus shown in FIG. 8. In the examples of FIGS. 9 and 10, video encoded data 10-1 and 10-2 have the same transmission start timing, and also have the same display timing (and output timing). Note that the video encoded data 10-1 and 10-2 may have different display timings (and output timings). In this case, for example, additional information representing the offset of the display timing (and output timing) between the video encoded data may be transmitted.

In the examples of FIGS. 9 and 10, assume that the video 14-1 corresponds to a video serving as a base, and the video 14-2 corresponds to an additional video displayed in synchronism with the video 14-1. Also assume that a transmission delay d1 in the channel 100-1 is shorter than a transmission delay d2 in the channel 100-2. However, this embodiment can also be applied to a case where the transmission delay d2 is shorter than the transmission delay d1 by modifying items in the following explanation.

FIG. 9 shows the operation of the video display apparatus shown in FIG. 8 when given the user information 28 (or display control information 29) corresponding to an instruction to synchronously display the videos 14-1 and 14-2 when the video 14-1 is displayed but the video 14-2 is not displayed.

The video display apparatus is given the user information 28 at time t0. That is, the video display apparatus displays the video 14-1 at the ×1 speed but not the video 14-2 up to the time t0. At this time, the display delay of the video 14-1 depends on the transmission delay d1.

Since the transmission delay d2 is longer than the transmission delay d1, the time information 12-2 has not caught up with the time information 12-1 at the time t0. Hence, at the time t0, the video display apparatus cannot synchronously display the videos 14-1 and 14-2. Hence, the decoding timing control unit 320 outputs, to the decoder 110-1, the decoding timing control information 13-1 for operating the decoder 110-1 at the ×p speed such that the time information 12-2 catches up with the time information 12-1. Here, p is a value smaller than 1.

For example, the decoding timing control unit 320 may calculate the transmission delay difference (=d2−d1) of the transmission delay d2 with respect to the transmission delay d1 based on the pieces of time information 12-1 and 12-2. In the example of FIG. 9, since the transmission delay difference is positive, the decoder 110-1 needs to be operated at a speed lower than the ×1 speed. Note that if the transmission delay difference is negative, not the decoder 110-1 but the decoder 110-2 needs to be operated at a speed lower than the ×1 speed. If the transmission delay difference is 2 sec, and p=0.833, the video 14-1 is displayed 0.167 sec later per sec. Hence, the time information 12-2 catches up with the time information 12-1 12 sec after.

The decoder 110-1 receives the decoding timing control information 13-1. Based on the decoding timing control information 13-1, the decoder 110-1 generates the video 14-1 by decoding video encoded data 11-1 at the ×p speed and outputs it to the video display unit 130. The video display unit 130 receives the video 14-1 and displays it. The display speed of the video 14-1 is the ×p speed because it is dependent on the operation speed of the decoder 110-1.

Since the transmission delay d2 is longer than the transmission delay d1, video encoded data 11-2 is received by the decoder 110-2 at a time later than the video encoded data 11-1. The decoder 110-2 controls the clock in it based on time information included in the video encoded data 11-2. The decoder 110-2 outputs the time information 12-2 measured by the clock to the decoding timing control unit 320.

The decoding timing control unit 320 receives the time information 12-2 from the decoder 110-2. The decoding timing control unit 320 outputs, to the decoder 110-2, the decoding timing control information 13-2 for operating the decoder 110-2 at the ×1 speed.

The decoder 110-2 receives the decoding timing control information 13-2. Based on the decoding timing control information 13-2, the decoder 110-2 generates the video 14-2 by decoding the video encoded data 11-2 at the ×1 speed and outputs it to the video display unit 130. The video display unit 130 receives the video 14-2. However, since the time information 12-2 has not caught up with the time information 12-1, the video display unit 130 does not display the video 14-2 (handles the display as completed at the presentation time of the video 14-2 and discards the video 14-2).

As described above, p<1. Hence, the time information 12-2 catches up with the time information 12-1 at a certain time (ts) after the operation of the decoder 110-2. ts is decided by p, the transmission delay d1, the transmission delay d2, and the time t0. At this time, the decoding timing control unit 320 outputs, to the decoder 110-1, the decoding timing control information 13-1 for operating the decoder 110-1 at the ×1 speed.

The decoder 110-1 receives the decoding timing control information 13-1. Based on the decoding timing control information 13-1, the decoder 110-1 generates the video 14-1 by decoding the video encoded data 11-1 at the ×1 speed and outputs it to the video display unit 130. The video display unit 130 receives the video 14-1. At this time, since the decoders 110-1 and 110-2 are operating at the ×1 speed, the video display unit 130 displays the videos 14-1 and 14-2 at the ×1 speed. At this time, the display delays of the videos 14-1 and 14-2 depend on the transmission delay d2.

FIG. 10 shows the operation of the video display apparatus shown in FIG. 8 when given the user information 28 (or display control information 29) corresponding to an instruction not to display the video 14-2 when the videos 14-1 and 14-2 are synchronously displayed.

The video display apparatus is given the user information 28 at time te. That is, the video display apparatus synchronously displays the videos 14-1 and 14-2 at the ×1 speed up to the time te. At this time, the display delays of the videos 14-1 and 14-2 depend on the transmission delay d2. The display delay of the video 14-1 cannot be changed only by simply stopping the operation of the decoder 110-2 (or discarding the video 14-2). That is, the display delay of the video 14-1 is delayed by the transmission delay difference (=d2−d1) as compared to a case where the video 14-1 is displayed alone.

Hence, the decoding timing control unit 320 outputs, to the decoder 110-1, decoding timing control information for operating the decoder 110-1 at the ×r speed so as to make the display delay of the video 14-1 short. Here, r is a value larger than 1. Note that making the display delay short is suitable when the video 14-1 includes real-time content (for example, disaster warning or live program). Note that the display delay can also immediately be minimized by skipping the display of the video 14-1. However, skipping the display without considering the content of the video 14-1 may create a sense of incongruity for the user.

For example, the decoding timing control unit 320 may calculate the transmission delay difference (=d2−d1) of the transmission delay d2 with respect to the transmission delay d1 based on the pieces of time information 12-1 and 12-2. In the example of FIG. 10, since the transmission delay difference is positive, the decoder 110-1 needs to be operated at a speed higher than the ×1 speed. Note that if the transmission delay difference is negative, the decoder 110-1 continues to operate at the ×1 speed. If the transmission delay difference is 2 sec, and r=1.2, the video 14-1 is displayed 0.2 sec earlier per sec. Hence, the display delay of the video 14-1 is minimized 10 sec after.

The decoder 110-1 receives the decoding timing control information 13-1. Based on the decoding timing control information 13-1, the decoder 110-1 generates the video 14-1 by decoding video encoded data 11-1 at the ×r speed and outputs it to the video display unit 130. The video display unit 130 receives the video 14-1 and displays it. The display speed of the video 14-1 is the ×r speed because it is dependent on the operation speed of the decoder 110-1.

As described above, r>1. Hence, the display delay of the video 14-1 is minimized (that is, the magnitude of the display delay depends on the transmission delay d1) at a certain time (tr) after the time te. tr is decided by r, the transmission delay d1, the transmission delay d2, and the time te. At this time, the decoding timing control unit 320 outputs, to the decoder 110-1, the decoding timing control information 13-1 for operating the decoder 110-1 at the ×1 speed.

The decoder 110-1 receives the decoding timing control information 13-1. Based on the decoding timing control information 13-1, the decoder 110-1 generates the video 14-1 by decoding the video encoded data 11-1 at the ×1 speed and outputs it to the video display unit 130. The video display unit 130 receives the video 14-1 and displays it at the ×1 speed. At this time, the display delay of the video 14-1 depends on the transmission delay d1.

In the examples of FIGS. 9 and 10, both the videos 14-1 and 14-2 can be displayed during the whole period illustrated. However, for example, the displayable period of the video 14-2 may be limited as compared to the displayable period of the video 14-1.

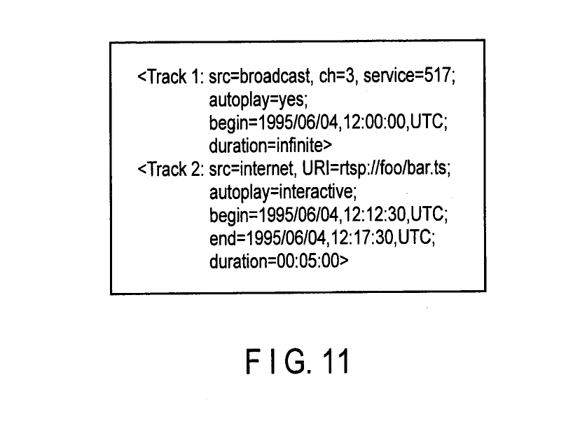

More specifically, the display control information 29 shown in FIG. 11 may be given to the control information interpretation unit 340. Concerning the video 14-1, the display control information 29 shown in FIG. 11 represents that the source is a broadcast wave, the channel number is 3, the service number is 517, the video is an automatic display content, the display start time is 12:00:00 (UTC) on Jun. 4, 1995, and the display period is infinite (that is, up to the end of the broadcast). Concerning the video 14-2, the display control information 29 shown in FIG. 11 represents that the source is the Internet, the URI is rtsp://foo/bar.ts, the video is a piece of content to be displayed based on operation information from the user, the display start time is 12:12:30 (UTC) on Jun. 4, 1995, the display end time is 12:17:30 (UTC) on Jun. 4, 1995, and the display period is 5 min. The display control information 29 can be either explicitly or implicitly described in at least one of the video encoded data 11-1 and 11-2.

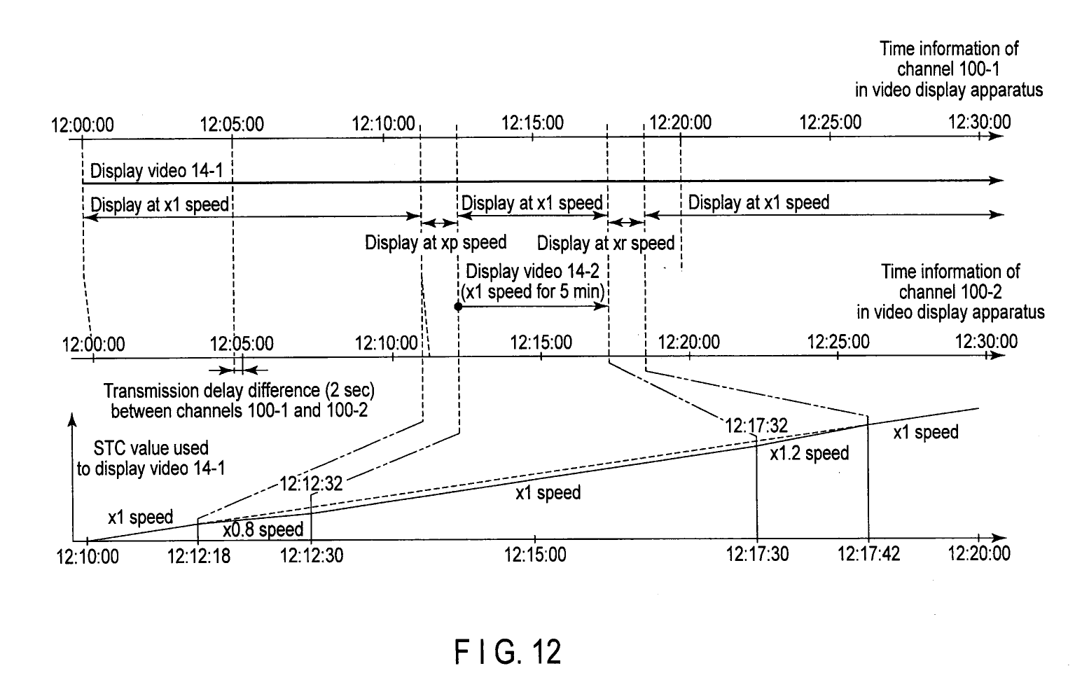

FIG. 12 shows the operation of the video display apparatus shown in FIG. 8 when given the display control information 29 shown in FIG. 11. In the example of FIG. 12, assume that the transmission delay d1 in the channel 100-1 is longer than the transmission delay d2 in the channel 100-2. Also assume that the transmission delay difference (=d2−d1) of the transmission delay d2 with respect to the transmission delay d1 is 2 sec. The decoding timing control unit 320 can either, for example, measure the transmission delay difference in advance or detect it based on system settings.

The video display apparatus first displays the video 14-1 at the ×1 speed. However, since the transmission delay d2 is longer than the transmission delay d1, the display delay of the video 14-1 preferably delays by an amount corresponding to the transmission delay difference up to the display start time of the video 14-2. Hence, the decoding timing control unit 320 outputs, to the decoder 110-1, the decoding timing control information 13-1 for operating the decoder 110-1 at the ×p speed at a certain time before the display start time of the video 14-2. Here, p is a value smaller than 1.

The time (that is, the start position of the period in which the decoder 110-1 operates at the ×p speed) at which the decoding timing control unit 320 outputs the decoding timing control information 13-1 to the decoder 110-1 is decided by p, the display start time (12:12:30 in the example of FIG. 12) of the video 14-2, and the transmission delay difference (2 sec in the example of FIG. 12). For example, when p=0.833, the STC value used for display of the video 14-1 delays by 2 sec in 12 sec. Hence, the decoding timing control unit 320 outputs, to the decoder 110-1, the decoding timing control information 13-1 for operating the decoder 110-1 at the ×0.833 speed 12 sec before the display start time of the video 14-2 (that is, when the STC value used for display of the video 14-1 is 12:12:20).

In the example of FIG. 12, the time information 12-2 catches up with the time information 12-1 at 12:12:30 that is the display start time of the video 14-2. At this time, the decoding timing control unit 320 outputs, to the decoder 110-1, the decoding timing control information 13-1 for operating the decoder 110-1 at the ×1 speed.

Display of the video 14-2 ends at 12:17:30 that is the display end time of the video 14-2. At this time, the display delay of the video 14-1 depends on the transmission delay d2 longer than the transmission delay d1, and is delayed by the transmission delay difference (=d2−d1) as compared to a case where the video 14-1 is displayed alone. The display delay of the video 14-1 is preferably early and seamlessly minimized. Hence, the decoding timing control unit 320 outputs, to the decoder 110-1, the decoding timing control information for operating the decoder 110-1 at the ×r speed so as to make the display delay of the video 14-1 short. Here, r is a value larger than 1.

The time (that is, the end position of the period in which the decoder 110-1 operates at the ×r speed) at which the display delay of the video 14-1 is minimized is decided by r, the display end time (12:17:30 in the example of FIG. 12) of the video 14-2, and the transmission delay difference (2 sec in the example of FIG. 12). For example, when r=1.2, the STC value used for display of the video 14-1 advances by 2 sec in 10 sec. Hence, the display delay of the video 14-1 is minimized 10 sec after the display end time of the video 14-2 (that is, when the STC value used for display of the video 14-1 is 12:17:42). At this time, the decoding timing control unit 320 outputs, to the decoder 110-1, the decoding timing control information 13-1 for operating the decoder 110-1 at the ×1 speed.

As described above, when switching the display state of videos based on a plurality of video encoded data transmitted via a plurality of channels, the video display apparatus according to the fifth embodiment seamlessly switches the display state. For example, when synchronously displaying another video in addition to a video under display, the video display apparatus operates a decoder corresponding to a channel whose transmission delay is not the longest at a speed lower than the ×1 speed, thereby seamlessly synchronizing the video under display and the other video. In addition, when ending display of some of videos under display, the video display apparatus operates decoders corresponding to the remaining videos at a speed higher than the ×1 speed as needed, thereby seamlessly minimizing the display delays of the remaining videos.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a first decoder which receives first video encoded data via a first channel and decodes the first video encoded data at a first speed to generate a first video;
a second decoder which receives second video encoded data via a second channel different from the first channel and decodes the second video encoded data at a second speed to generate a second video; and
a controller which, when the first video encoded data is received earlier than the second video encoded data, controls the first speed so as to generate a period in which the first speed becomes lower than a ×1 speed until second time information of the second decoder catches up with first time information of the first decoder, wherein when the first video encoded data is received earlier than the second video encoded data, the first video is displayed at the first speed until the second time information catches up with the first time information.

2. The processor according to claim 1, wherein the controller controls the second speed to the ×1 speed when the second video encoded data is received later than the first video encoded data, and controls the first speed to the ×1 speed after the second time information catches up with the first time information.

3. The processor according to claim 1, wherein when the first video encoded data is received earlier than the second video encoded data, the first video and the second video are displayed at one of the first speed and the second speed after the second time information catches up with the first time information.

4. The processor according to claim 1, wherein when the first video encoded data is received earlier than the second video encoded data, a third image generated by combining a first image included in the first video and a second image included in the second video is displayed at one of the first speed and the second speed after the second time information catches up with the first time information.

5. The processor according to claim 1, wherein when the first video encoded data is received earlier than the second video encoded data, a first image included in the first video is displayed at one of the first speed and the second speed and a second image included in the second video is displayed, as a subimage, at the same speed as that of the first image after the second time information catches up with the first time information.

6. The processor according to claim 1, wherein the first channel comprises a channel of digital broadcasting, and the second channel comprises an IP network.

7. The processor according to claim 1, wherein the first channel and the second channel comprise channels of digital broadcasting and are in different physical layers.

8. The processor according to claim 1, wherein the first channel and the second channel comprise channels of digital broadcasting of the same physical layer and are in different logical layers.

9. The processor according to claim 1, further comprising an interpretation unit configured to interpret at least one of user information and display control information to obtain control information concerning display states of the first video and the second video,
wherein the controller controls the first speed and the second speed based on the control information and current display states of the first video and the second video.

10. The processor according to claim 9, wherein when the control information for instructing to synchronously display the first video and the second video is input in a case where the first video is displayed but the second video is not displayed, and the first video encoded data is received earlier than the second video encoded data, the controller controls the first speed so as to generate the period in which the first speed becomes lower than the ×1 speed until the second time information catches up with the first time information.

11. The processor according to claim 10, wherein when the first video corresponds to a specific situation during the period in which the first speed is lower than the ×1 speed, the controller pauses display of the first video.

12. The processor according to claim 9, wherein when the control information for instructing to end displaying the second video is input in a case where the first video and the second video are synchronously displayed, and the first video encoded data is received earlier than the second video encoded data, the controller controls the first speed so as to generate a period in which the first speed becomes larger than the ×1 speed.

13. The processor according to claim 12, wherein when the first video corresponds to a specific situation during the period in which the first speed is higher than the ×1 speed, the controller skips display of the first video.

14. The processor according to claim 9, wherein when the control information for instructing to synchronously display a plurality of videos including the first video and the second video is input, the controller synchronously displays the plurality of videos based on a video having a longest transmission delay out of the plurality of videos.

15. The processor according to claim 9, wherein the interpretation unit presents a user with information for accepting a user operation corresponding to an instruction to select a video to be synchronously displayed from a plurality of videos including the first video and the second video.

16. The processor according to claim 9, wherein the user information includes attribute information of a user, and
the interpretation unit automatically selects, based on the attribute information of the user, a video to be synchronously displayed from a plurality of videos including the first video and the second video.

17. The processor according to claim 9, wherein the display control information includes information representing a time at which the second video is displayed in synchronism with the first video,
when the control information for instructing to synchronously display the first video and the second video is input, and the first video encoded data is received earlier than the second video encoded data, the controller controls the first speed so as to generate the period in which the first speed becomes lower than the ×1 speed before a display start time of the second video, and
a start position of the period in which the first speed is lower than the ×1 speed is decided by the display start time of the second video, a transmission delay difference between the first channel and the second channel, and the first speed during the period.

18. A information processing method comprising:
receiving first video encoded data via a first channel and decoding the first video encoded data at a first speed to generate a first video;
receiving second video encoded data via a second channel different from the first channel and decoding the second video encoded data at a second speed to generate a second video;
when the first video encoded data is received earlier than the second video encoded data, controlling the first speed so as to generate a period in which the first speed becomes lower than a ×1 speed until second time information of the second decoder catches up with first time information of the first decoder; and
when the first video encoded data is received earlier than the second video encoded data, displaying the first video at the first speed until the second time information catches up with the first time information.

19. An information processor comprising:
a processor; and
a memory that stores processor-executable instructions that, when executed by the processor, cause the processor to:
receive first video encoded data via a first channel and second video encoded data via a second channel different from the first channel
decode the first video encoded data at a first speed to generate a first video and the second video encoded data at a second speed to generate a second video;
control the first speed so as to generate a period in which the first speed becomes than a ×1 speed until second time information of the second decoder catches up with first time information of the first decoder when the first video encoded data is received earlier than the second video encoded data; and
display the first video at the first speed until the second time information catches up with the first time information when the first video encoded data is received earlier than the second video encoded data.
